(19) United States
(12) Patent Application Publication
(10) Pub. No.: US 2012/0287456 A1
(43) Pub. Date: Nov. 15, 2012

(54) IMAGE FORMING SYSTEM

(75) Inventor: Seiji Innami, Osaka (JP)

(73) Assignee: SHARP KABUSHIKI KAISHA, Osaka (JP)

(21) Appl. No.: 13/467,572

(22) Filed: May 9, 2012

(30) Foreign Application Priority Data
May 10, 2011 (JP) 2011-105217

(51) Int. Cl. G06K 15/02

(52) U.S. Cl. 358/1.13

(57) ABSTRACT

Provided is adding information to various places of document data easily and efficiently according to a request from a user of the moment. A condition specification accepting portion accepts specification of at least one condition from among a plurality of conditions for deciding a place to which a predetermined function is added in the document data; a display portion displays a list of pages each of which includes a place which is matched with the condition of which specification is accepted by the condition specification accepting portion; an adding place setting portion selects a page to which the predetermined function is added from among the pages included in the list displayed by the display portion and sets the place in the selected page matched with the condition of which specification is accepted, as a place to which the predetermined function is added.

### CROSS-NOTING PARAGRAPH

This non-provisional application claims priority under 35 U.S.C. §119(a) on Patent Application No. 2011-105217 filed in JAPAN on May 10, 2011, the entire contents of which are hereby incorporated herein by reference.

### FIELD OF THE INVENTION

The present invention relates to an image forming system for adding a predetermined function to computerized document data.

### BACKGROUND OF THE INVENTION

Recently, it is becoming possible that various information is added to computerized document data by scanning a paper document and a user is able to view the document on a mobile terminal. Information added to a document includes, in addition to information of a format of the document and information of a layout at the time of displaying the document on the mobile terminal, multimedia data such as a moving image and audio, image data changed interactively according to an operation of a user, information of a font, information of a digital rights management (DRM) function and the like.

For example, Japanese Laid-Open Patent Publication No. 2003-69810 discloses an information adding method for adding correction information for a content of electronic data to be displayed or printed to the electronic data. In the information adding method, when information of a correction character and an adding position of the correction character is input by an operation of a mouse or the like of a user, additional information comprised of such information is created. Electronic data in which the correction character is arranged based on the additional information is then displayed or printed.

However, the technology of Japanese Laid-Open Patent Publication No. 2003-69810 described above only includes as a method of specifying an adding position of a correction character, the method of specifying the adding position by operating a mouse or the like by a user which is not capable of adding information to various places easily and efficiently according to a request of a user of the moment.

### SUMMARY OF THE INVENTION

An object of the present invention is to provide an image forming system capable of adding information easily and efficiently to various places of document data according to a request of a user of the moment.

An object of the present invention is to provide an image forming system in which a predetermined function is added to computerized document data, comprising: a condition specification accepting portion which accepts specification of at least one condition from among a plurality of conditions for deciding a place to which the predetermined function is added in the document data; a display portion which displays a list of pages each of which includes a place which matches with the condition on which specification is accepted by the condition specification accepting portion; and an adding place setting portion which selects a page to which the predetermined function is added from among the pages included in the list displayed by the display portion, and in the selected page, sets the place which matches with the condition on which specification is accepted, as the place to which the predetermined function is added.

Another object of the present invention is to provide the image forming system, wherein the condition includes a condition of a character size in the place to which the predetermined function is added.

Another object of the present invention is to provide the image forming system, wherein the condition includes a condition of the number of blank lines in the place to which the predetermined function is added.

Another object of the present invention is to provide the image forming system, wherein the condition includes a condition that the place to which the predetermined function is added is included in a page specified by a user.

Another object of the present invention is to provide the image forming system, wherein the condition includes a condition that the place to which the predetermined function is added is a place specified by a user on a page specified by the user.

### BRIEF DESCRIPTION OF THE DRAWINGS

FIG. 1 is a diagram explaining a concept of function adding processing according to an embodiment of the present invention;

FIG. 2 is a diagram showing an example of a configuration of an image forming system according to the embodiment of the present invention;

FIG. 3 is a flowchart for explaining an example of processing procedure of the function adding processing according to the embodiment of the present invention;

FIG. 4 is a flowchart for explaining an example of processing procedure of the function adding processing according to the embodiment of the present invention;

FIG. 5 is a diagram showing an example of a setting screen of validity/invalidity of the function adding processing displayed on a display portion;

FIG. 6 is a diagram showing an example of a condition setting screen of a condition for deciding an adding place of a function displayed on the display portion;

FIG. 7 is a flowchart for explaining an example of processing procedure of generation processing of function added document data;

FIG. 8 is a flowchart for explaining an example of processing procedure of generation processing of the function added document data;

FIG. 9 is a flowchart for explaining an example of processing procedure of generation processing of the function added document data;

FIG. 10 is a diagram showing an example of a setting screen on which a character size input area is displayed;

FIG. 11 is a diagram showing an example of a page list display screen displaying a list of pages to each of which a function is added;

FIG. 12 is a diagram showing an example of the page list display screen in a case where a page is selected;

FIG. 13 is a diagram showing an example of the page list display screen which accepted input of an instruction to add a function;

FIG. 14 is a flowchart for explaining an example of processing procedure of function generation processing;

FIG. 15 is a diagram showing an example of a function list display screen displaying a list of functions added to document data;

FIG. 16 is a diagram showing an example of the function list display screen in a case where a function is added;

FIG. 17 is a diagram showing an example of a page list display screen displaying an icon of an added function;

FIG. 18 is a diagram showing an example of a condition setting screen on which a condition of the number of blank lines is specified;

FIG. 19 is a diagram showing an example of a page list display screen displaying a page searched on condition of the number of blank lines;

FIG. 20 is a diagram showing an example of a page list display screen in a case where a page is selected;

FIG. 21 is a diagram showing an example of a condition setting screen on which a condition of page specification is specified;

FIG. 22 is a diagram showing an example of a page list display screen displaying a page searched on condition of the page specification;

FIG. 23 is a diagram showing an example of a page list display screen in a case where a page is selected;

FIG. 24 is a diagram showing an example of a condition setting screen on which a condition of user setting is specified;

FIG. 25 is a diagram showing an example of a page list display screen displaying a page searched on condition of the user setting;

FIG. 26 is a diagram showing an example of a page list display screen in a case where a page is selected;

FIG. 27 is a diagram showing an example of a condition setting screen on which a condition of all page checking is specified;

FIG. 28 is a diagram showing an example of a page list display screen which is displayed in a case where the condition of the all page checking is specified;

FIG. 29 is a diagram showing an example of a page list display screen in which a page number is input in a page number display area;

FIG. 30 is a diagram showing an example of a page list display screen in a case where a place to which a function adding marker is added is specified;

FIG. 31 is a diagram showing an example of a page list display screen on which a page is displayed in which a place to which a function is added is set;

FIG. 32 is a diagram showing an example of a page list display screen in a case where there are a plurality of pages in which places to which functions are added are set; and

FIG. 33 is a block diagram showing an example of a configuration of an image forming system to which a required instruction or data are transferred from an external device.

### PREFERRED EMBODIMENTS OF THE INVENTION

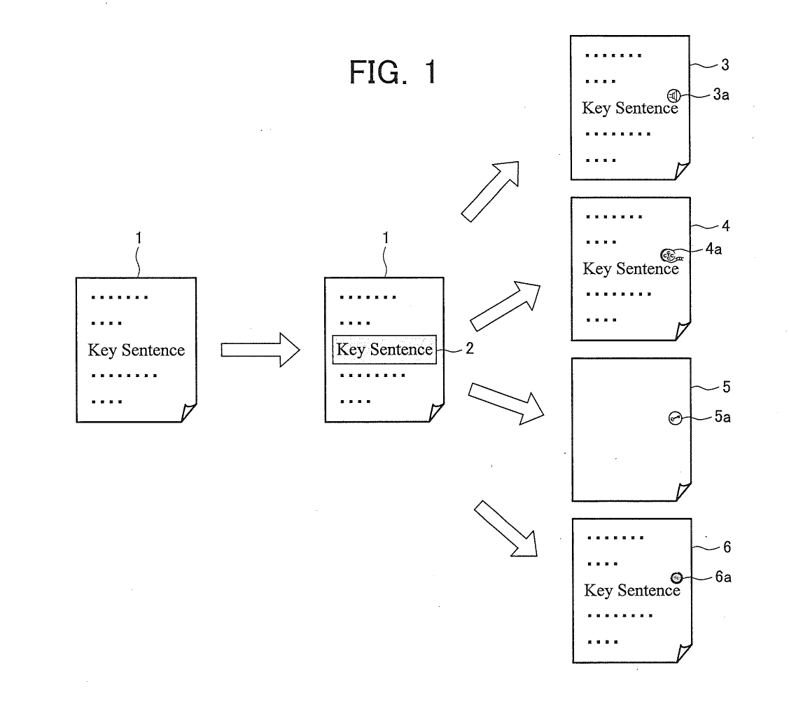

FIG. 1 is a diagram explaining a concept of function adding processing according to an embodiment of the present invention, and in the function adding processing according to the present invention, various functions are added to document data 1 having a format such as an electronic book format. For example, a function to output audio, a function to reproduce a moving image, a function to protect the document data 1 with a password, a function to make a connection to a web site, and the like are added to the document data 1.

At the time, it is required to decide at which place of the document data 1 the above functions are added. This function adding processing makes a user to specify any of a plurality of conditions which should be satisfied by a place to which a function is added. The plurality of conditions are, for example, conditions such as “a character size”, “the number of blank lines”, “page specification”, “user setting” of a place to which a function is embedded.

For example, when the condition of the “character size” is specified by a user, a place 2 including a character with a character size or more which is input by the user is searched from the document data 1, and a list of pages each of which includes such a place 2 is displayed. The user then selects a page from the list, and document data in which various functions specified by the user are added to the searched place 2 on the selected page is generated.

For example, when a user specifies the function to output audio, document data 3 is generated in which the function to output audio is added to the above place 2. In the document data 3, when an icon 3a displayed on a display is clicked by a mouse or the like, or the icon 3a displayed on a touch panel is touched by a user's finger, predetermined audio is output.

Further, when the user specifies the function to reproduce a moving image, document data 4 is generated in which the function to reproduce a moving image is added to the above place 2. In the document data 4, when an icon 4a displayed on a display is clicked by a mouse or the like, or the icon 4a displayed on a touch panel is touched by a user's finger, a predetermined moving image is reproduced.

Further, when the user specifies the function to protect the document data 1 with a password, document data 5 is generated in which the function to protect the document data 1 with a password is added to the above place 2. In the document data 5, when an icon 5a displayed on a display is clicked by a mouse or the like, or the icon 5a displayed on a touch panel is touched by a user's finger, a screen to input a password is displayed so as to accept input of a password by the user. In a case where the password matches with a password which is set in advance, a content of the documents data 1 is able to be viewed.

Further, when the user specifies the function to make a connection to a website, document data 6 is generated in which the function to make a connection to a website is added to the above place 2. In the document data 6, when an icon 6a displayed on a display is clicked by a mouse or the like, or when the icon 6a displayed on a touch panel is touched by a user's finger, connection is made to a website having a predetermined URL so that the website is displayed.

Similarly, when “the number of blank lines” is specified by the user as the condition which should be satisfied by a place to which a function is added, a place including a blank line with the number of blank lines or more which is input by the user is searched from the document data 1 so that a list of pages each of which includes such a place is displayed. In a similar way to the case where the condition of the “character size” is specified, a page is selected by the user from the list, and document data is generated in which various functions specified by the user are added to a searched place on the selected page.

Further, when the condition of “page specification” is specified by the user, a page corresponding to a page number input by the user is searched from the document data 1 so that a list of the searched pages is displayed. Here, it is assumed that a place to which a function is added in each page is set in advance. Then, a user selects a page from the list, and document data is generated in which various functions specified by the user are added to a place set in advance on the selected page.

Further, when the condition of the “user setting” is specified by the user, a list of pages each of which includes the place set as a place to which a function is added from the document data 1 by the user is displayed. Then, a user selects a page from the list, and document data is generated in which various functions specified by the user are added to the set place on the selected page.

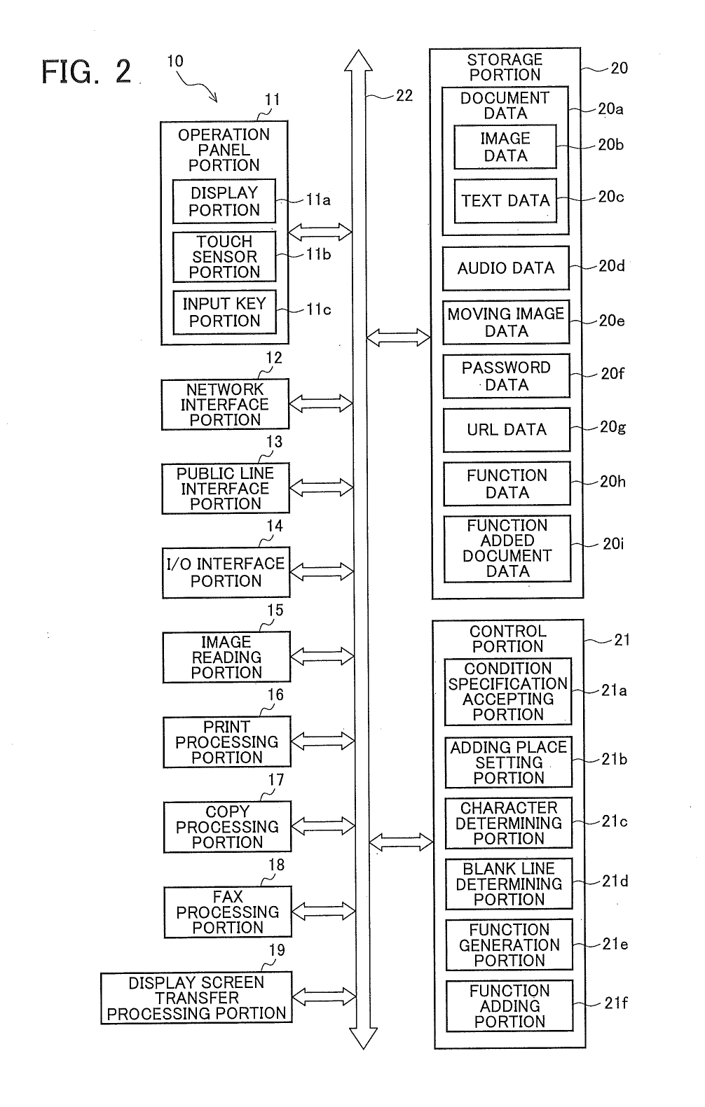

FIG. 2 is a diagram showing an example of a configuration of an image forming system 10 according to the embodiment of the present invention, and the image forming system 10 is an apparatus for forming an image such as an MFP (Multifunction Peripheral), a printer, or a FAX, for example.

The image forming system 10 is provided with an operation panel portion 11, a network interface portion 12, a public line interface portion 13, an I/O interface portion 14, an image reading portion 15, a print processing portion 16, a copy processing portion 17, a FAX processing portion 18, a display screen transfer processing portion 19, a storage portion 20, a control portion 21 and a system bus 22.

The operation panel portion 11 is a panel portion to display various information and to accept input of various information from a user, and the operation panel portion 11 is provided with a display portion 11a, a touch sensor portion 11b, and an input key portion 11c.

The display portion 11a is a display device such as a liquid crystal display, and the touch sensor portion 11b is a sensor portion to detect a place on the display portion 11a which is touched by a user. For example, when a button is displayed on the display portion 11a, the touch sensor portion 11b detects whether or not the button is touched by the user. The input key portion 11c is a key portion such as a numerical keypad, a keyboard or a button for accepting input of information from a user.

The network interface portion 12 is an interface portion for communicating with another device via a network, and the network interface portion 12 performs communication by the standard such as Ethernet (Registered trademark), Token Ring, or FDDI (Fiber-Distributed Data Interface), for example.

The public line interface portion 13 is an interface portion for performing Fax transmission/reception with another FAX device via a public line, and the I/O interface portion 14 is an interface portion for communicating with an external device in a case of directly connecting with the external device without the network.

The image reading portion 15 is an image reading device such as a scanner for reading a document of paper or the like to generate document data of an electronic book format or the like. The document data is data in a format with a transparent text in which character recognition of the read image data is performed by using an OCR (Optical Character Reader) and the resultant text data is made transparent to be superimposed on the image data.

The print processing portion 16 is a processing portion for printing document data. The copy processing portion 17 is a processing portion for copying a document of paper or the like. The FAX processing portion 18 is a processing portion for transmitting/receiving a FAX.

The display screen transfer processing portion 19 is a processing portion for transferring information of a display image displayed on the display portion 11a to an external device. The external device displays a screen similar to a screen displayed on the display portion 11a based on the information, accepts input of various information from a user using the screen, and transmits the information to the image forming system 10. Thereby, the user is able to operate the image forming system 10 from a location remote from the image forming system 10.

The storage portion 20 is a storage device such as a memory or a hard disk. The storage portion 20 stores document data 20a, audio data 20d, moving image data 20e, password data 20f, URL (Uniform Resource Locator) data 20g, function data 20h, function added document data 20i and the like.

The document data 20a is electronic data in a format with a transparent text of a document read by the image reading portion 15. For example, the document data 20a is electronic book data which is viewable from an electronic book terminal. The document data 20a includes image data 20b and text data 20c. The image data 20b is image data of a document read by the image reading portion 15. The text data 20c is text data obtained by character recognition of the image data 20b which is made transparent to be superimposed on the image data 20b.

The audio data 20d is audio data to be output with the audio output function when the audio output function is embedded in the document data 20a. The moving image data 20e is moving image data to be reproduced with the moving image reproducing function when a moving image reproducing function is embedded in the document data 20a.

The password data 20f is data of a password used for user authentication by the password protection function when a password protection function is embedded in the document data 20a. The URL data 20g is data of a URL of a website which is a link destination connected by the web link function when a web link function is embedded in the document data 20a.

The function data 20h is data of functions embedded in the document data 20a, and the function data 20h includes, for example, data of the audio output function which executes output of the audio data 20d, data of the moving image reproduction function which executes reproduction of the moving image data 20e, data of the password protection function which protects the document data 20a with a password, data of the web link function which makes connection to the website and the like.

The function added document data 20i is function added document data which is generated by the image forming system 10, and the function added document data 20i includes, for example, document data with the audio output function added thereto, document data with the moving image reproduction function added thereto, document data with the password protection function added thereto, document data with the web link function added thereto, and the like.

The control portion 21 is a control device such as a CPU (Central Processing Unit) for totally controlling the image forming system 10, and the control portion 21 includes a condition specification accepting portion 21a, an adding place setting portion 21b, a character determining portion 21c, a blank line determining portion 21d, a function generation portion 21e, a function adding portion 21f.

The condition specification accepting portion 21a is a processing potion to accept from a user specification of any condition from among a plurality of conditions for deciding a place to which the functions are added in the document data 20a, such as the audio output function, the moving image reproduction function, the password protection function and the web link function.

The above plurality of conditions include, for example, a condition of a character size of a place to which a function is added, a condition of the number of blank lines of a place to which a function is added, a condition that a place to which a function is added is included in a page specified by the user, a condition that a place to which a function is added is a place set by a user in a page specified by the user, and the like.

When the character size in the place to which a function is added is specified by a user, a function is added to a place with a character having a character size of a specified character size or more. When the number of blank lines in the place to which a function is added is specified by a user, a function is added to a place having the number of blank lines including no character being the specified number of blank lines or more.

When a page of the place to which a function is added is specified by a user, a function is added to a predetermined place (such as upper right corner of the page, for example) on the page. When a page to which a function is added is specified by the user, and a place to which a function is added is further set by a user, a function is added to the above place on the above page.

The adding place setting portion 21b is a processing portion to set a place which matches the above condition as a place to which a function is added. The character determining portion 21c is a processing portion to determine, when a character size is specified as the condition of a place to which a function is added, a size or a type of a character included in the text data 20c. Specifically, the character determining portion 21c extracts a character one by one from the text data 20c and detects the size of the character. The character determining portion 21c then determines whether or not the detected character size is the character size or more specified by the user.

The blank line determining portion 21d is a processing portion to count the number of blank lines in consecutive lines included in the text data 20c and to determine whether or not the resultant number of lines is the number of blank lines or more specified by the user, when the number of blank lines is specified as a condition of the place to which a function is added.

The function generation portion 21e is a processing portion to generate data of a function embedded in document data, and, for example, when the audio output function is embedded in the document data, the function generation portion 21e reads audio data to be output from the audio data 20d and generates data of the audio output function which outputs the audio data

When the moving image reproduction function is embedded in the document data, the function generation portion 21e reads the moving image data to be reproduced from the moving image data 20e and generates data of the moving image reproduction function which outputs the moving image data.

When the password protection function is embedded in the document data, the function generation portion 21e reads information of a password from the password data 20f and generates data of the password protection function having a function to perform user authentication with the password.

When the web link function is embedded in the document data, the function generation portion 21e reads information of a URL of a link destination from the URL data 20g, connects to a website of the URL, and generates data of the web link function displaying the website.

The function adding portion 21f is a processing portion to generate the function added document data 20i with various functions generated by the function generation portion 21e added thereto.

The system bus 22 is a system bus for connection between each function portions. The system bus 22 includes a data bus, an address bus, a control signal bus and the like.

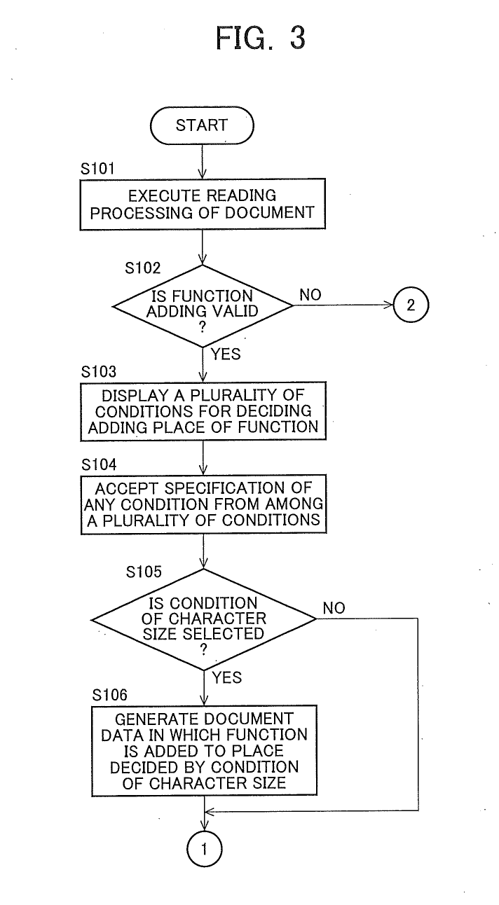

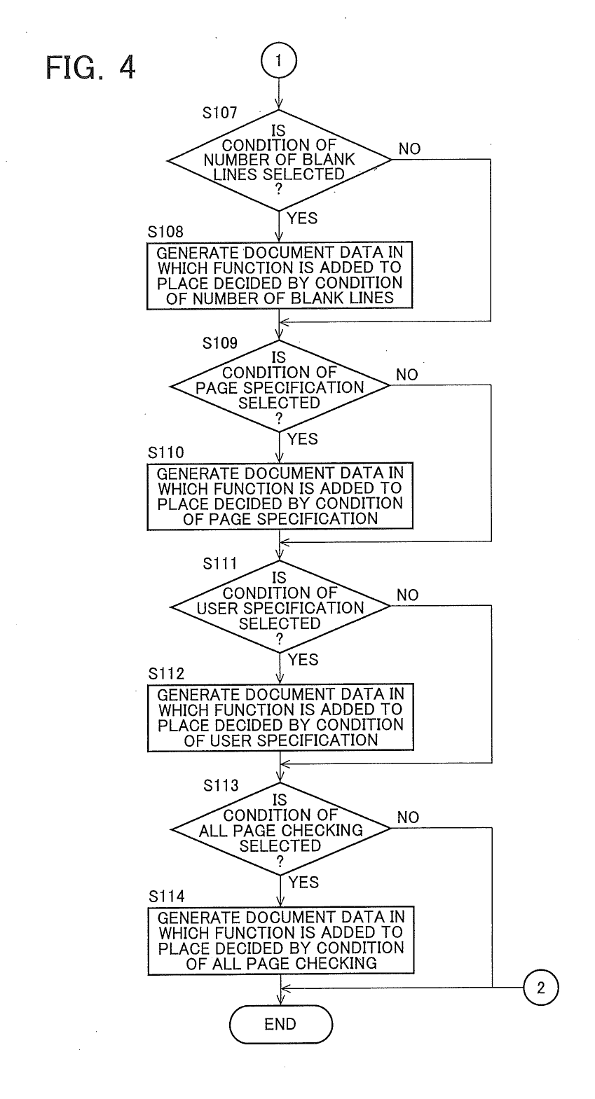

FIG. 3 and FIG. 4 are flowcharts for explaining an example of processing procedure of function adding processing according to the embodiment of the present invention, and the image reading portion 15 of the image forming system 10 executes reading processing of a document as shown in FIG. 3 (step S101). The function adding portion 211 then determines whether or not the function adding processing is set to valid (step S102). Setting to valid/invalid is made when the function adding portion 21f displays on the display portion 11a a setting screen of validity/invalidity of the function adding processing and input to validate the function adding processing is accepted from a user.

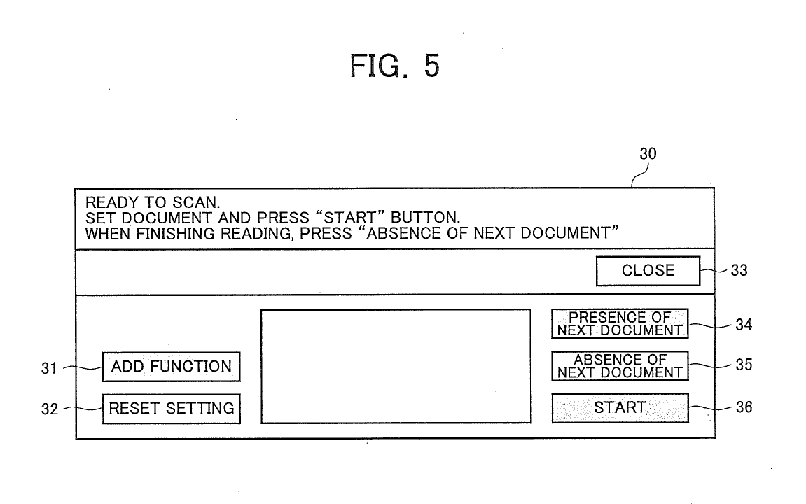

FIG. 5 is a diagram showing an example of a setting screen 30 of validity/invalidity of the function adding processing displayed on the display portion 11a. On the setting screen 30 shown in FIG. 5, a function adding validation button 31, a setting reset button 32, a close button 33, a next document reading instruction button 34, a reading finish instruction button 35, and a start button 36 are displayed. When each button is touched by a user, a display color of each button is changed so as to be known that each button is touched (see the function adding validation button 31, the next document reading instruction button 34 and the start button 36 in FIG. 5).

The function adding validation button 31 is a button for accepting from a user an instruction to validate function adding processing. The setting reset button 32 is a button for accepting from a user an instruction to initialize a content set on the setting screen 30. The close button 33 is a button for closing the setting screen 30 to finish reading processing of a document.

The next document reading instruction button 34 is a button for accepting, after reading a document, an instruction to read a next document from the user. The reading finish instruction button 35 is a button for accepting, after reading a document, an instruction to finish reading a document from a user. The start button 36 is a button for accepting an instruction to start reading a document from a user.

When the function adding validation button 31 is touched by a user on the setting screen 30 shown in FIG. 5, the function adding portion 21f determines the function adding processing is set to valid.

Returning to the description of FIG. 3, at step S102, when the function adding processing is not set to valid (in the case of NO at step S102), as shown in FIG. 4, the function adding processing is finished accordingly.

When the function adding processing is set to valid (in the case of YES at step S102), the function adding portion 21f displays on the display portion 11a a plurality of conditions for deciding an adding place of a function (step S103).

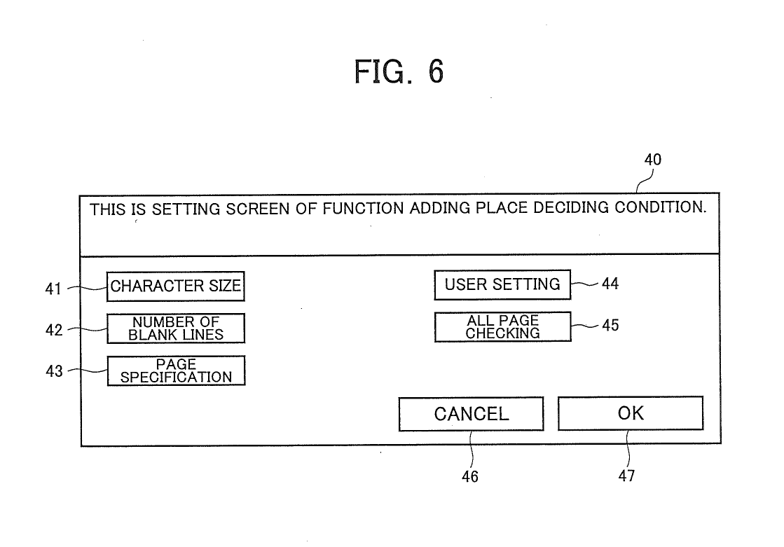

FIG. 6 is a diagram showing an example of a condition setting screen 40 of a condition for deciding an adding place of a function displayed on the display portion 11a, and on the condition setting screen 40 shown in FIG. 6, a character size button 41, a number of blank lines button 42, a page specification button 43, a user setting button 44, an all page checking button 45, a cancel button 46, and an OK button 47 are displayed.

The character size button 41 is a button for accepting from a user an instruction to set the adding place of a function by a character size. The number of blank lines button 42 is a button for accepting from a user an instruction to set the adding place of a function by the number of blank lines. The page specification button 43 is a button for accepting from a user an instruction to set the adding place of a function by a page number specified by a user.

The user setting button 44 is a button for accepting from a user an instruction to set the adding place of a function by a character string specified by a user. The all page checking button 45 is a button for accepting from a user an instruction to set the adding place of a function one by one with touch operation of a user while each page of the document data 20a is being confirmed by a user on a preview screen.

The cancel button 46 is a button for accepting, when there is a selected button on the condition setting screen 40 shown in FIG. 6, an instruction to cancel all the selection from a user. The OK button 47 is a button for accepting, when there is a selected button on the condition setting screen 40, an instruction to confirm the selection from a user.

Returning to the description of FIG. 3, after the processing at step S103, the condition specification accepting portion 21a accepts from a user specification of any condition from among the plurality of conditions described above (step S104). The function adding portion 21f then determines whether or not the condition of the character size is selected by the user (step S105).

When the condition of the character size is selected by the user (in the case of YES at step S105), the adding place setting portion 21b, the character determining portion 21c, the blank line determining portion 21d, the function generation portion 21e, and the function adding portion 21f generate the function added document data 20i in which a function is added to a place decided on the condition of the character size (step S106). This processing is described in detail below.

When the condition of the character size is not selected by the user (in the case of NO at step S105), or after the processing at step S106, the function adding portion 21f determines whether or not the condition of the number of blank lines is selected by the user as shown in FIG. 4 (step S107).

When the condition of the number of blank lines is selected by the user (in the case of YES at step S107), the adding place setting portion 21b, the character determining portion 21c, the blank line determining portion 21d, the function generation portion 21e, and the function adding portion 21f generate the function added document data 20i in which a function is added to a place decided on the condition of the number of blank lines (step S108). This processing is described in detail below.

When the condition of the number of blank lines is not selected by the user (in the case of NO at step S107), or after the processing at step S108, the function adding portion 21f determines whether or not the condition of page specification is selected by the user (step S109).

When the condition of the page specification is selected by the user (in the case of YES at step S109), the adding place setting portion 21b, the character determining portion 21c, the blank line determining portion 21d, the function generation portion 21e, and the function adding portion 21f generate the function added document data 20i in which a function is added to a place decided on the condition of page specification (step S110). This processing is described in detail below.

When the condition of the page specification is not selected by the user (in the case of NO at step S109), or after the processing at step S110, the function adding portion 21f determines whether or not the condition of user specification is selected by the user (step S111).

When the condition of the user specification is selected by the user (in the case of YES at step S111), the adding place setting portion 21b, the character determining portion 21c, the blank line determining portion 21d, the function generation portion 21e, and the function adding portion 21f generate the function added document data 20i in which a function is added to a place decided on the condition of user specification (step S112). This processing is described in detail below.

When the condition of the user specification is not selected by the user (in the case of NO at step S111), or after the processing at step S112, the function adding portion 21f determines whether or not the condition of all page checking is selected by the user (step S113).

When the condition of the all page checking is selected by the user (in the case of YES at step S113), the adding place setting portion 21b, the character determining portion 21c, the blank line determining portion 21d, the function generation portion 21e, and the function adding portion 21f generate the function added document data 20i in which a function is added to a place decided on the condition of all page checking (step S114). This processing is described in detail below.

When the condition of the all page checking is not selected by the user (in the case of NO at step S113), or after the processing at step S114, the function adding processing is finished.

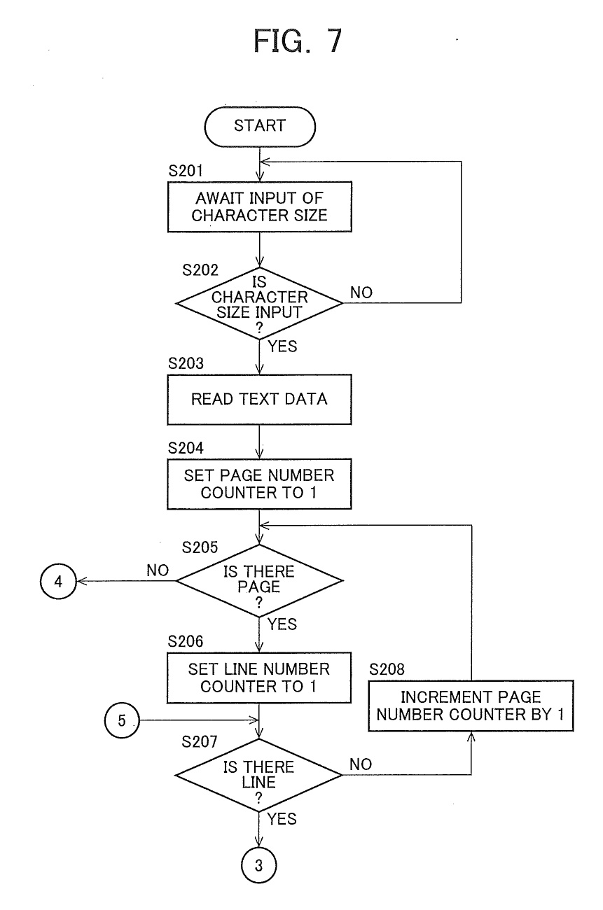

Next, the generation processing of document data described at step S106 in FIG. 3, step S108, step S110, step S112 and step S114 in FIG. 4 will be described in detail with reference to FIG. 7 to FIG. 9. FIG. 7 to FIG. 9 are flowcharts for explaining an example of processing procedure of generation processing of the function added document data, and here at first, a case of deciding a place to which a function is added using the condition of a character size is described, followed by the description for the other conditions.

As shown in FIG. 7, the function adding portion 21f of the image forming system 10 displays on the display portion 11a a setting screen to accept input of a character size, and awaits input of the character size from a user (step S201). The function adding portion 21f then determines whether or not the character size is input by the user (step S202).

When the character size is not input by the user (in the case of NO at step S202), the process shifts to step S201 and the function adding portion 21f continuously awaits input of the character size from the user.

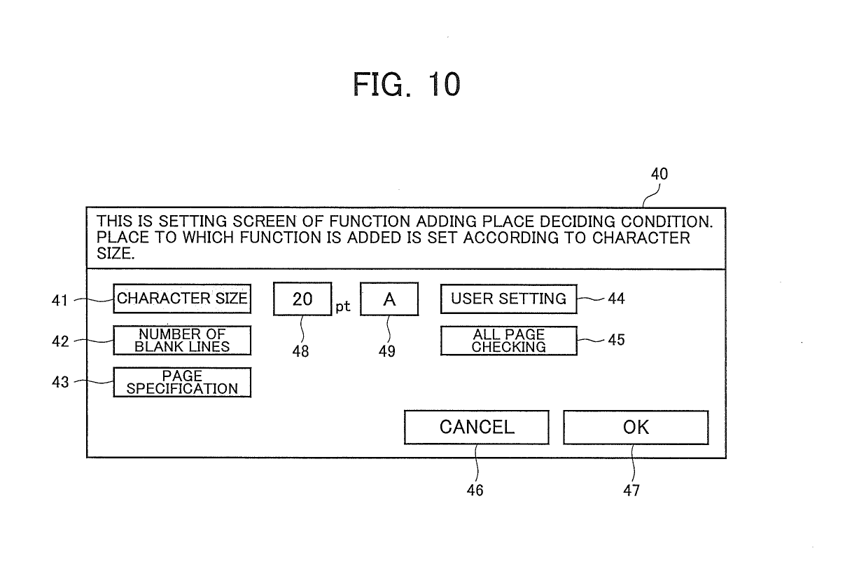

FIG. 10 is a diagram showing an example of a condition setting screen 40 on which a character size input area 48 is displayed which is displayed on the display portion 11a. The condition setting screen 40 shown in FIG. 10 is a screen displayed on the display portion 11a when the character size button 41 is touched by a user on the condition setting screen 40 shown in FIG. 6.

On the condition setting screen 40 shown in FIG. 10, in addition to each button shown in FIG. 6, the character size input area 48 and a character size preview area 49 are displayed. The character size input area 48 is an area displaying a character size input by operation of the input key portion 11c and the like by the user. The character size preview area 49 is an area displaying a preview of a character in the character size input in the character size input area 48. In the example of FIG. 10, a preview of a character “A” in the character size of 20 pt is displayed in the character size preview area 49.

Returning to the description of FIG. 7, at step S202, when the character size is input by the user (in the case of YES at step S202), the function adding portion 21f reads the text data 20c (step S203). The function adding portion 21f then sets a page number counter to 1 (step S204).

The function adding portion 21f thereafter determines whether or not there is a page of the page number corresponding to the value of the page number counter (step S205). When there is the page of the page number corresponding to the value of the page number counter (in the case of YES at step S205), the function adding portion 21f sets a line number counter to 1 (step S206).

The function adding portion 21f then determines whether or not there is a line of the line number corresponding to a value of the line number counter (step S207). When there is no line of the line number corresponding to the value of the line number counter (in the case of NO at step S207), the function adding portion 21f increments the page number counter by 1 (step S208). The process then shifts to step S205 and determines whether or not there is a page of a page number corresponding to the value of the page number counter, and subsequent processing is continued.

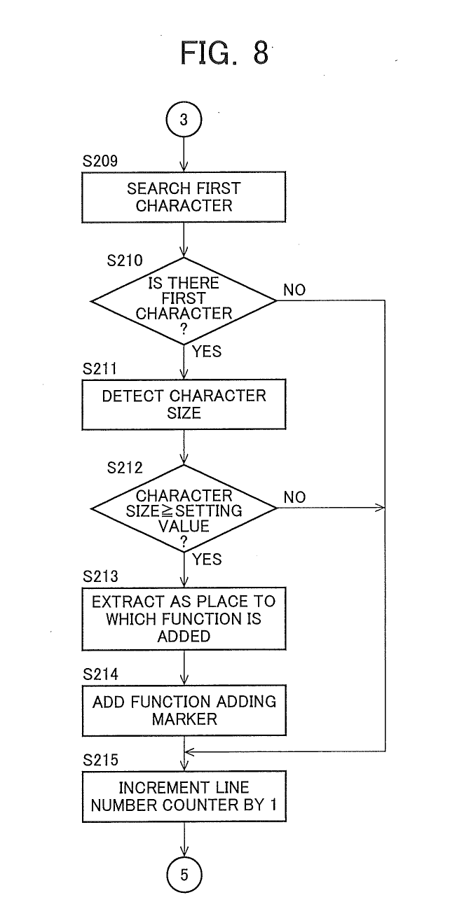

At step S207, when there is a line of the line number corresponding to the value of the line number counter (in the case of YES at step S207), as shown in FIG. 8, the character determining portion 21c searches a first character in the line (step S209).

The character determining portion 21c then determines whether or not there is a first character (step S210). When there is no first character (in the case of NO at step S210), the process shifts to the step S215 and the function adding portion 21f increments the line number counter by 1 (step S215). The process then shifts to step S207 in FIG. 7 and determination is made on whether or not there is a line of the line number corresponding to the value of the line number counter, and subsequent processing is continued.

When there is the first character at step S210 in FIG. 8 (in the case of YES at step S210), the character determining portion 21c detects a character size of the first character (step S211).

The character determining portion 21c, for example, detects the character size of the first character using information of a character size (font size) included in the text data 20c. The character determining portion 21c may alternatively detect the character size from a length of a diagonal line or vertical and horizontal lengths in a rectangle portion occupied by the character, or a ratio of a character area of each character relative to an entire page.

The character determining portion 21c thereafter determines whether or not the character size of the first character is a setting value or more that is set by a user in the character size input area 48 of FIG. 10 (step S212). When the character size is not the setting value or more (in the case of NO at step S212), the process shifts to step S215 and subsequent processing is continued.

When the character size is the setting value or more (in the case of YES at step S212), the adding place setting portion 21b extracts as places to which a function is added the page of the page number corresponding to the value of the page number counter and the line of the line number corresponding to the value of the line number counter (step S213). The adding place setting portion 21b then adds a function adding marker to an extracted line (step S214). The process subsequently shifts to the step S215 and subsequent processing is continued.

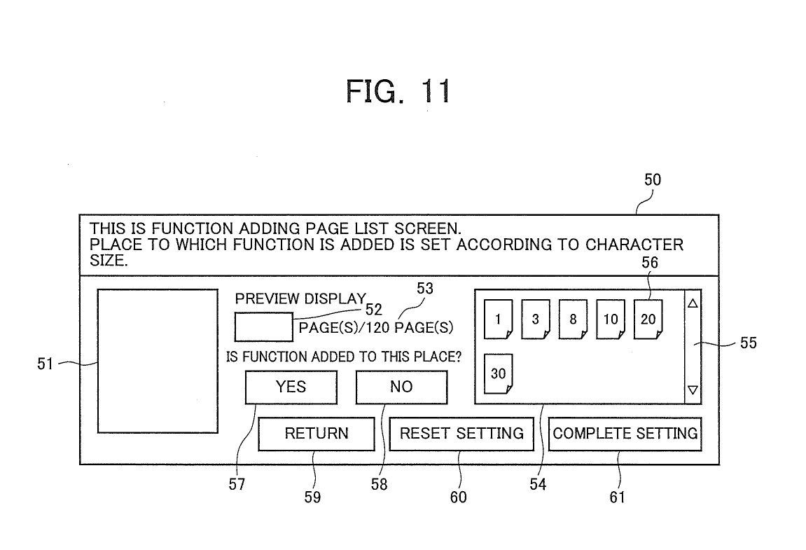

FIG. 11 is a diagram showing an example of a page list display screen 50 displaying a list of pages to each of which a function is added. The page list display screen 50 is a screen displayed on the display portion 11a by the function adding portion 21f when a character size is input by a user in the character size input area 48 on the condition setting screen 40 as shown in FIG. 10 and the OK button 47 is touched.

On the page list display screen 50, displayed are a preview area 51, a page number display area 52, a total number of pages display area 53, a page list display area 54, a scroll bar 55, a function addition page number 56, an adding place setting button 57, an adding place non-setting button 58, a return button 59, a reset button 60, and a setting completion button 61.

The preview area 51 is an area in which, when the function addition page number 56 displayed in the page list display area 54 is selected by the user, an image picture of the page corresponding to the function addition page number 56 is displayed.

The page number display area 52 is an area in which, when the function addition page number 56 displayed in the page list display area 54 is selected by the user, the function addition page number 56 is displayed. The total number of pages display area 53 is an area in which the total number of pages of the document data 20a is displayed.

The page list display area 54 is an area in which a list of the function addition page numbers 56 of the pages to each of which a function is added is displayed. The scroll bar 55 is a scroll bar for scrolling the page list display area 54 when not all of the function addition page numbers 56 are able to be displayed in the page list display area 54. The function addition page number 56 is information of a page number of a page to which a function is added.

The adding place setting button 57 is a button for accepting from a user an instruction to add a function to a place extracted on the condition of a character size, and the adding place non-setting button 58 is a button for accepting from a user an instruction for not adding a function to the place extracted on the condition of the character size.

The return button 59 is a button for accepting from a user an instruction to return a display to the condition setting screen 40 shown in FIG. 10, the reset button 60 is a button for accepting from a user an instruction to cancel all the setting made by operating the adding place setting button 57 and the adding place non-setting button 58, and the setting completion button 61 is a button for accepting from a user an instruction to confirm all the setting made by operating the adding place setting button 57 and the adding place non-setting button 58.

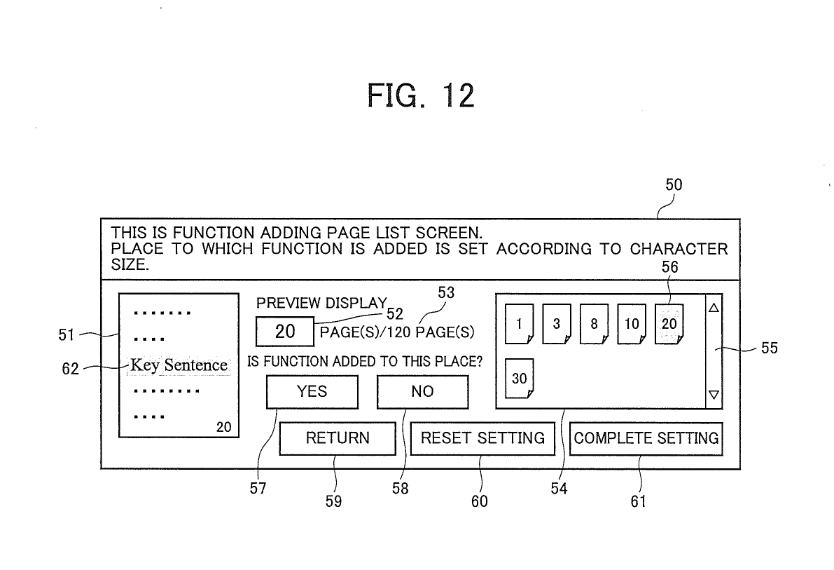

FIG. 12 is a diagram showing an example of the page list display screen 50 in the case where a page is selected, and in the example of FIG. 12, in the page list display area 54, the function addition page number 56 corresponding to page 20 is selected by a user. In this case, a display color of the function addition page number 56 is changed. In addition, in the page number display area 52, “20” is displayed. In the preview area 51, an image picture of the document data 20a in the 20th page is further displayed.

In the image picture displayed in the preview area 51, when a character size of “K” which is a first character in a line including a character string of “Key Sentence” is the setting value or more which is input in the character size input area 48 in FIG. 10, the function addition marker 62 indicating to add a function to the line is added.

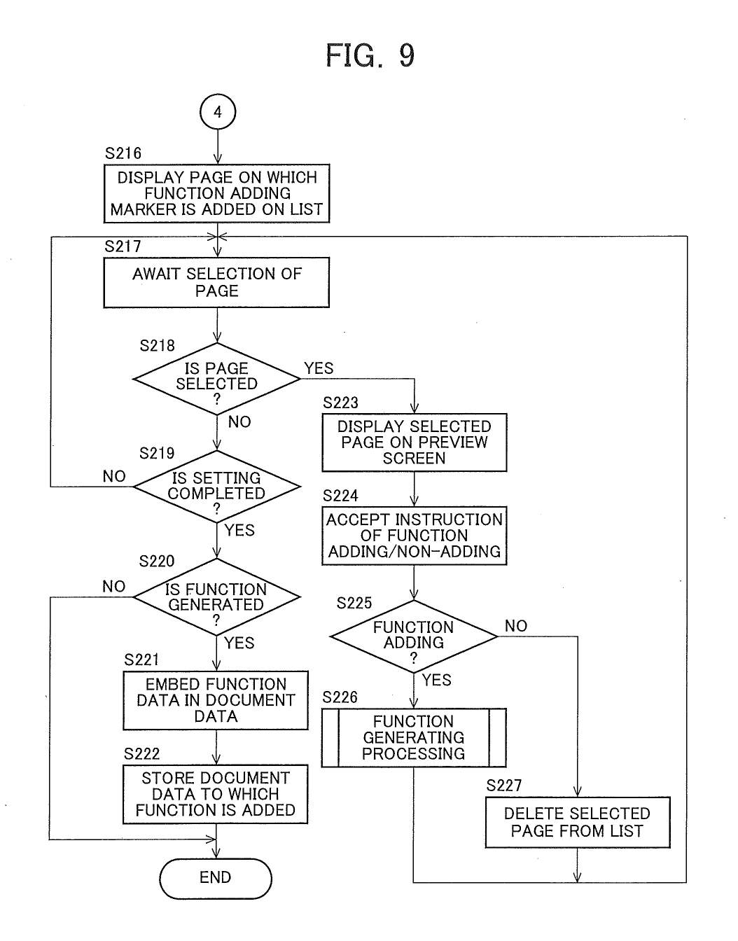

Returning to the description of FIG. 7, at step S205, when there is no page of a page number corresponding to a value of a page number counter (in the case of NO at step S205), as shown in FIG. 9, the function adding portion 21f controls the display portion 11a to display in the page list display area 54 the function addition page number 56 of the page to which the function addition marker 62 is added (step S216).

At the time, the function adding portion 21f controls the display portion 11a to eliminate the function addition page number 56 of the page to which the function addition marker 62 is not added from the page list display area 54.

The function adding portion 21f thereafter awaits any function addition page number 56 to be selected by a user from among the function addition page numbers 56 displayed in the page list display area 54 (step S217). The function adding portion 21f then determines whether or not the function addition page number 56 is selected from a user (step S218).

When the function addition page number 56 is selected by the user (in the case of YES at step S218), the function adding portion 21f controls the display portion 11a to display in the preview area 51 an image picture of the page corresponding to the selected function addition page number 56 (step S223).

On the page displayed in the preview area 51, the function adding portion 21f then accepts input from a user instructing on whether or not to add a function to a place to which the function addition marker 62 is added (step S224). Specifically, the function adding portion 21f accepts input from a user instructing on whether or not to add a function by detecting which one of the adding place setting button 57 and the adding place non-setting button 58 shown in FIG. 12 is touched by the user.

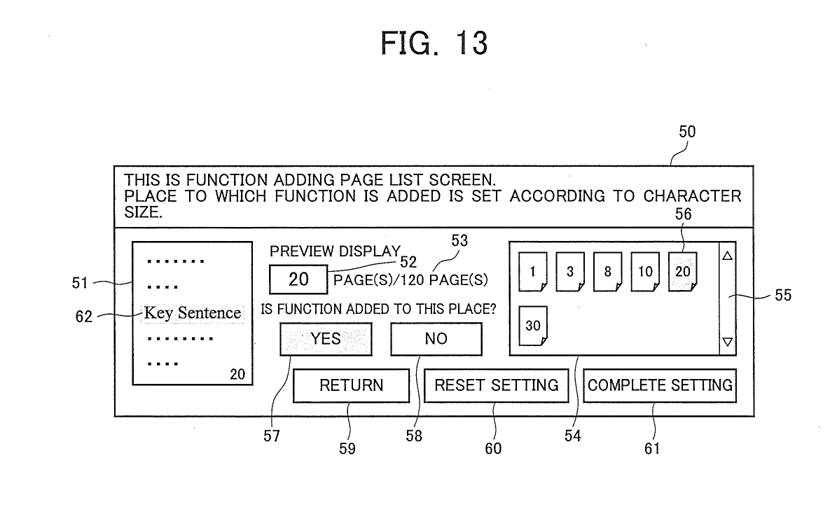

FIG. 13 is a diagram showing an example of a page list display screen 50 which received the input of instruction to add a function, and in the example of FIG. 13, as the result of that the adding place setting button 57 shown in FIG. 12 is touched by the user, a display color of the adding place setting button 57 is changed. Thereby, a function is to be added to a line including the character string of “Key Sentence” on the 20th page.

Returning to the description of FIG. 9, after the processing at step S224, the function adding portion 21f determines whether or not an instruction to add a function to a place to which the function addition marker 62 is added is accepted from a user (step S225).

When the instruction to add a function to a place to which the function addition marker 62 is added is accepted from the user (in the case of YES at step S225), the function generation portion 21e and the function adding portion 21f execute function generating processing to generate a function to be added to the document data 20a (step S226). This function generating processing is described in detail below. Thereafter, the process shifts to the step S217 and the subsequent processing is executed.

At step S225, in the case of not accepting the instruction to add a function to a place to which the function addition marker 62 is added from the user and the adding place non-setting button 58 shown in FIG. 12 is touched by the user (in the case of NO at step S225), the function adding portion 21f controls the display portion 11a to eliminate the selected function addition page number 56 from the page list display area 54 (step S227). Then the process shifts to the step S217 to execute the subsequent processing.

At step S218, in the case where the page is not selected by the user (in the case of NO at step S218), the function adding portion 21f determines whether or not a setting completion button 61 shown in FIG. 13 is touched by the user (step S219).

When the setting completion button 61 is not touched by the user (in the case of NO at step S219), the process shifts to step S217 and subsequent processing is executed. When the setting completion button 61 is touched by the user (in the case of YES at step S219), the function adding portion 21f determines whether or not the function generating processing at step S226 is executed (step S220).

When the function generating processing is executed (in the case of YES at step S220), the function adding portion 21f embeds in the document data 20a the function data 20h generated in the function generating processing so as to generate the function added document data 201 (step S221). The function adding portion 21f then stores the function added document data 201 in the storage portion 20 (step S222), and the function adding processing is terminated.

At step S220, when the function generating processing is not executed (in the case of NO at step S220), the function adding processing is finished accordingly.

After the function adding processing is terminated, the function added document data 201 is transferred to a mobile terminal such as an electronic book terminal according to a request from a user so as to be viewed by the user and the added function is used.

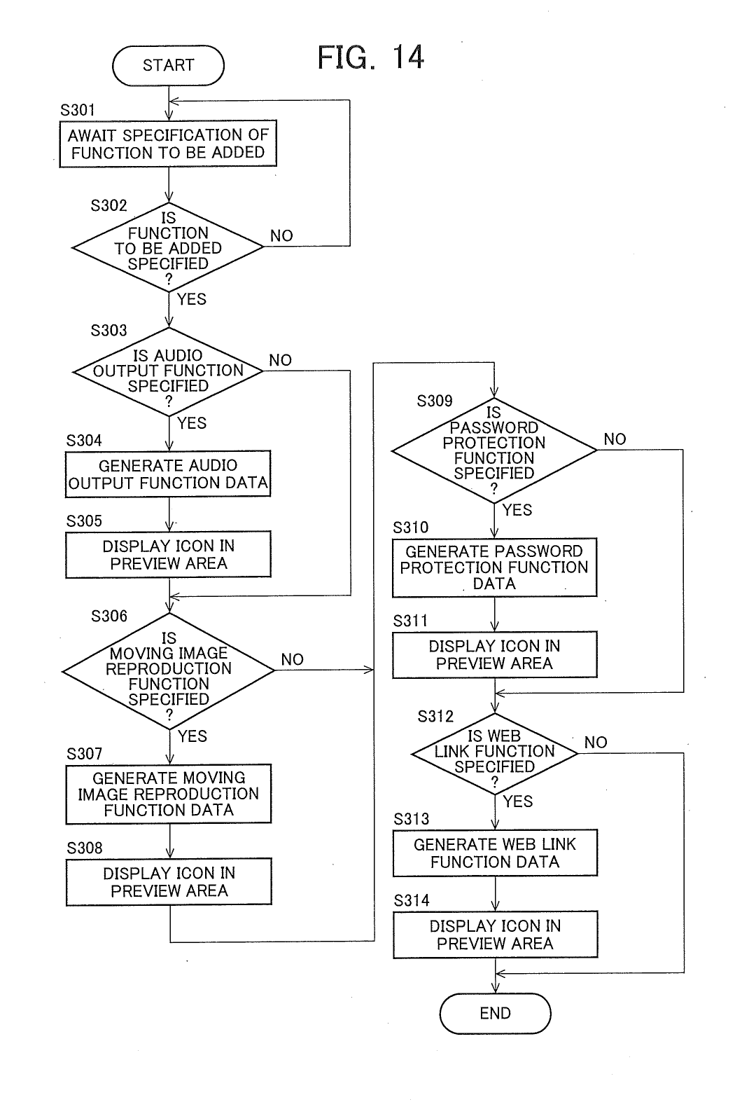

Next, processing procedure of function generating processing shown at step S226 in FIG. 9 will be described in detail with reference to the flowchart of FIG. 14. As shown in FIG. 14, the function adding portion 21f of the image forming system 10 awaits specification of a function to be added to the document data 20a from a user (step S301). The function adding portion 21f then determines whether or not a function to be added to the document data 20a is specified by the user (step S302). When the function to be added to the document data 20a is not specified by the user (in the case of NO at step S302), the process shifts to the step S301 and subsequent processing is executed.

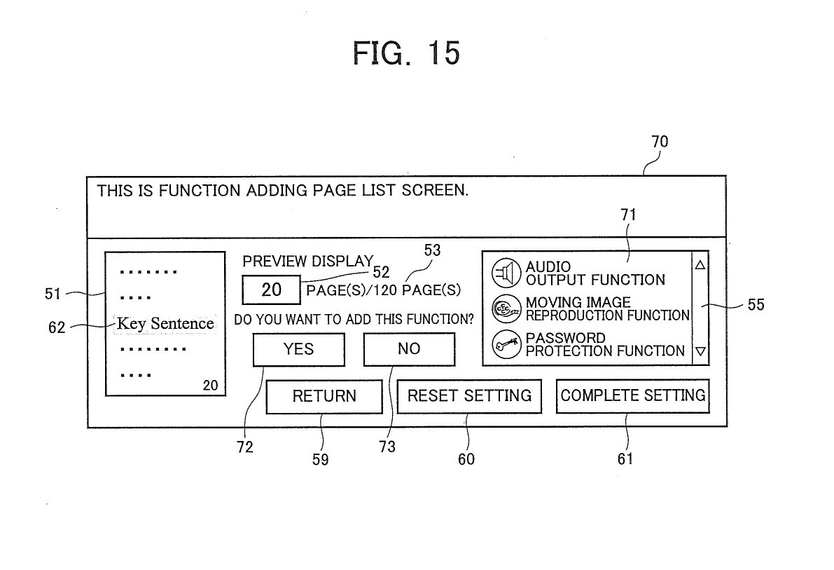

FIG. 15 is a diagram showing an example of a function list display screen 70 displaying a list of functions each of which is added to the document data 20a, and the function list display screen 70 is a screen displayed on the display portion 11a by the function adding portion 21f when the adding place setting button 57 on the page list display screen 50 shown in FIG. 13 is touched by a user, and further, the setting completion button 61 is touched by the user.

On the function list display screen 70, displayed are the preview area 51, the page number display area 52, the total number of pages display area 53, a function list display area 71, the scroll bar 55, a function adding button 72, a function non-adding button 73, the return button 59, the reset button 60, and the setting completion button 61.

The preview area 51, the page number display area 52, the total number of pages display area 53, the return button 59, the reset button 60, and the setting completion button 61 are respectively the same as the preview area 51, the page number display are 52, the total number of pages display area 53, the return button 59, the reset button 60, and the setting completion button 61 described in FIG. 10.

The function list display area 71 is an area in which a list of functions added to the document data 20a is displayed. The scroll bar 55 is a scroll bar for making the function list display area 71 to scroll when not all the functions are able to be displayed in the function list display area 71.

The function adding button 72 is a button for accepting from a user an instruction to add a function to a place of the function addition marker 62 on the page displayed in the preview area 51. The function non-adding button 73 is a button for accepting from a user an instruction for not adding a function to the place of the function addition marker 62 on the page displayed in the preview area 51.

When each function displayed on the function list display area 71 is specified by touch operation of the user, and the function adding button 72 is further touched by the user, the function specified by the user is added to the place of the function addition marker 62.

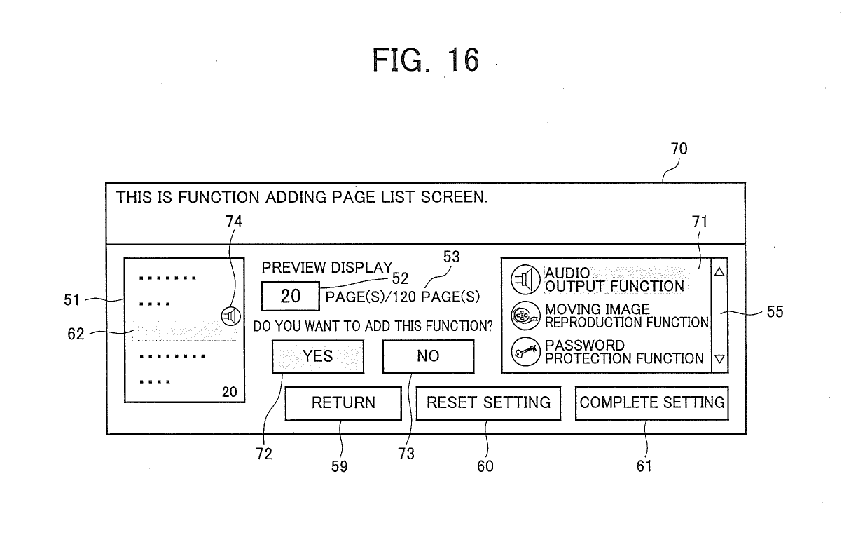

FIG. 16 is a diagram showing an example of the function list display screen 70 in the case where a function is added, and when a function (“audio output function” in the example FIG. 16) is specified by touch operation of the user in the function list display area 71, a display color of the specified function is changed. And when the function adding button 72 is further touched by the user, a display color of the function adding button 72 is changed. Further, an icon 74 of the function specified by the user is displayed to a place to which the function addition marker 62 is added on the page displayed in the preview area 51.

Returning to the description of FIG. 14, at step S302, when a function added to the document data 20a is specified by a user (in the case of YES at step S302), the function adding portion 21f determines whether or not the specified function is the audio output function (step S303).

When the specified function is the audio output function (in the case of YES at step S303), the function generation portion 21e reads the audio data 20d from the storage portion 20 and generates audio output function data having a function to output the audio data 20d, using the read audio data 20d (step S304).

The function adding portion 21f then controls the display portion 11a to display the icon 74 of the audio output function in the place of the function addition marker 62 in the preview area 51 shown in FIG. 16 (step S305).

Note that, on the function list display screen 70 shown in FIG. 16, when the function non-adding button 73 is touched by the user, the page list display screen 50 described in FIG. 11 is displayed again. In this case, in the page list display area 54, for the function addition page number 56 on the page to which a function is added prior to touching of the function non-adding button 73 by the user, an icon of the added function is displayed.

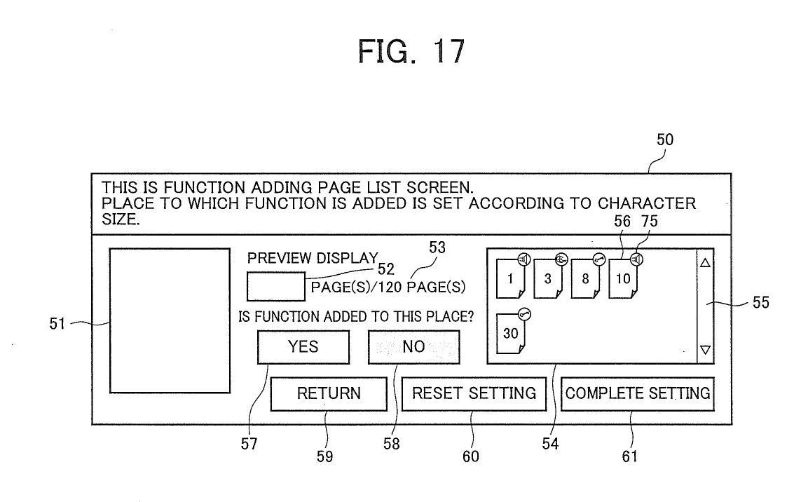

FIG. 17 is a diagram showing an example of the page list display screen 50 displaying icons of the added functions. In the page list display area 54 shown in FIG. 17, icons 75 of the added functions are displayed by being associated with the function addition page numbers 56 respectively.

The function addition page number 56 included in the page list display area 54 is then specified by a touch of the user, and further, the adding place non-setting button 58 is touched by the user, the setting to add a function to a page corresponding to the function addition page number 56 is thus cancelled and the function addition page number 56 is eliminated from the page list display area 54.

In the example of FIG. 17, the function addition page number 56 on the 20th page to which the audio output function is added is specified by a user, and further as the result of the touch of the adding place non-setting button 58 by the user, setting to add the audio output function to the function addition page number 56 on the 20th page is cancelled so that the function addition page number 56 on the 20th page is eliminated from the page list display area 54.

Returning to the description of FIG. 14, after the processing at step 305, or at step S303, in the case where the specified function is not the audio output function (in the case of NO at step S303), the function adding portion 21f determines whether or not the specified function is a moving image reproduction function (step S306).

When the specified function is the moving image reproduction function (in the case of YES at step S306), the function generation portion 21e reads the moving image data 20e from the storage portion 20, and generates moving image reproduction function data having a function to reproduce the moving image data 20e, using the read moving image data 20e (step S307).

The function adding portion 21f then controls the display portion 11a to display an icon of a moving image reproduction function in the place of the function addition marker 62 in the preview area 51 shown in FIG. 16 (step S308).

After the processing at step S308, or at step S306, in the case where the specified function is not the moving image reproduction function (in the case of NO at step S306), the function adding portion 21f determines whether or not the specified function is a password protection function (step S309).

When the specified function is the password protection function (in the case of YES at step S309), the function generation portion 21e reads the password data 20f from the storage portion 20, and generates password protection function data having a function to perform user authentication with the password data 20f, using the read password data 20f (step S310).

The function adding portion 21f then controls the display portion 11a to display an icon of a password protection function in the place of the function addition marker 62 in the preview area 51 shown in FIG. 16 (step S311).

After the processing at step S311, or at step S309, in the case where the specified function is not the password protection function (in the case of NO at step S309), the function adding portion 21f determines whether or not the specified function is a web link function (step S312).

When the specified function is the web link function (in the case YES at step S312), the function generation portion 21e reads the URL data 20g from the storage portion 20, connects to a website having a URL included in the URL data 20g using the read URL data 20g, and generates web link function data having a function to display the website (step S313).

The function adding portion 21f then controls the display portion 11a to display an icon of a web link function in the place of the function addition marker 62 in the preview area 51 shown in FIG. 16 (step S314).

After the processing at step S314, or at step S312, in the case where the specified function is not the web link function (in the case of NO at step S312), the function adding processing is finished. Thereafter, the process shifts to step S217 shown in FIG. 9 and subsequent processing is executed.

In this manner, since the condition of the character size is used as the condition for deciding a place to which a function is added in document data, it becomes possible to add a function to a conspicuous place with a large character size so that the function becomes easy to be used when viewing the document.

Note that, in FIG. 7 and FIG. 8, a case has been described where the condition of the character size is specified by the user as the condition for deciding a place to which a function is added, however, as described below, a place to which a function is added may be decided even when other conditions are specified.

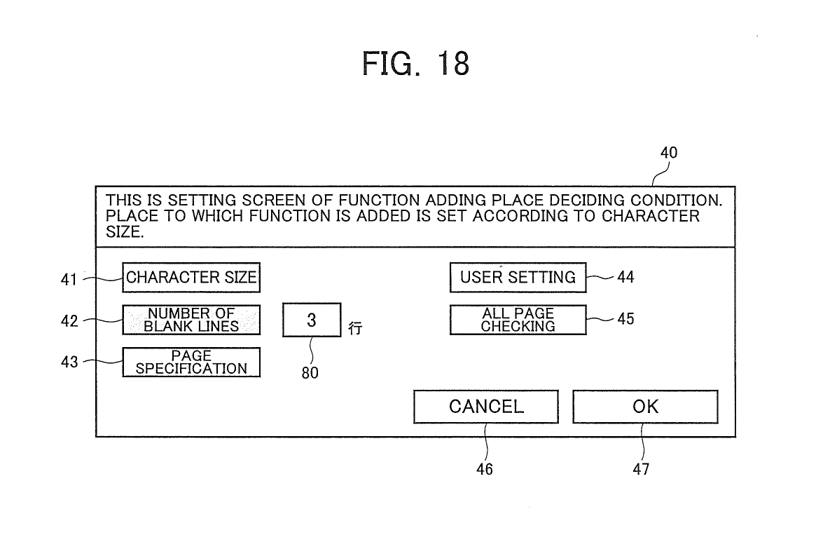

First, a case will be described where a condition of the number of blank lines is specified by a user as the condition for deciding a place to which a function is added. FIG. 18 is a diagram showing an example of the condition setting screen 40 on which the condition of the number of blank lines is specified.

On the condition setting screen 40 shown in FIG. 6, when the number of blank lines button 42 is touched by the user, as shown in FIG. 18, a number of blank lines input area 80 is displayed. The number of blank lines input area 80 is an area in which the number of blank lines input by operating the input key portion 11c and the like by the user is displayed. In the example of FIG. 18, in the number of blank lines input area 80, “3” is displayed.

On the condition setting screen 40 an example of which is shown in FIG. 18, when the number of blank lines is input by a user, the blank line determining portion 21d determines whether or not there is a page including a place having the number of blank lines that is the input number of blank lines or more. The function adding portion 21f then controls the display portion 11a to display as a list pages each of which is determined by the blank line determining portion 21d as including a place having the number of blank lines that is the input number of blank lines or more.

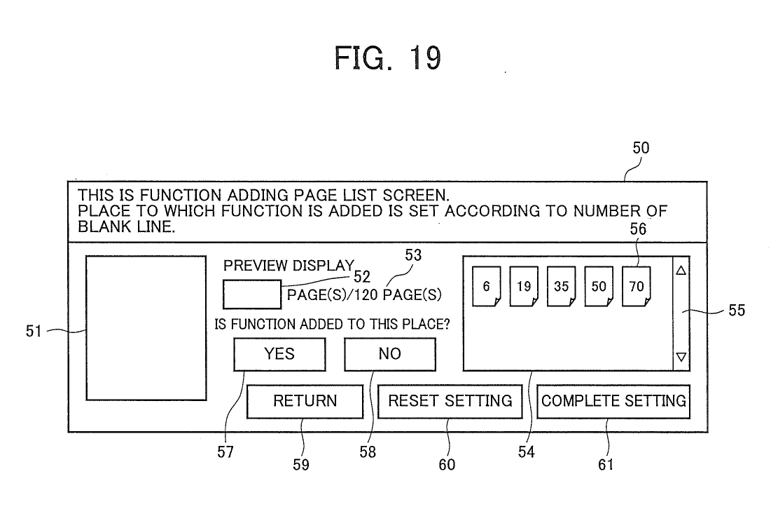

FIG. 19 is a diagram showing an example of the page list display screen 50 for displaying a page searched on the condition of the number of blank lines, and the page list display screen 50 displayed in FIG. 19 is different from the page list display screen 50 shown in FIG. 11 in that the function addition page number 56 displayed in the page list display area 54 is the function addition page number 56 on the page searched on the condition of the number of blank lines.

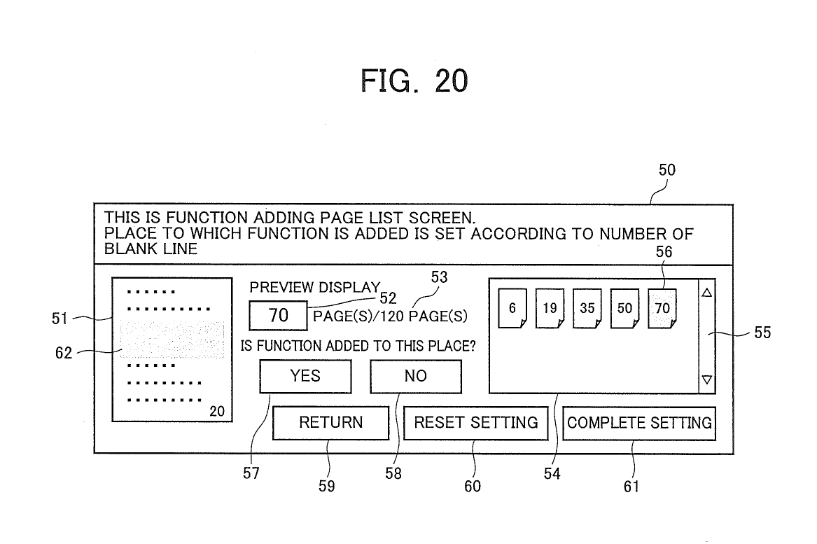

FIG. 20 is a diagram showing an example of the page list display screen 50 in the case where a page is selected, and in the case of FIG. 20, in the page list display area 54, the function addition page number 56 on the 70th page is selected by the user. In this case, a display color of the function addition page number 56 is changed. Further, in the page number display area 52, “70” is displayed. In the preview area 51, an image picture on the 70th page is further displayed.

In the image picture displayed in the preview area 51, to a place having the number of blank lines of 3 lines or more, the function addition marker 62 indicating to add a function to the place is added. Subsequent processing is the same as in the case where the user specifies the condition of the character size as the condition for deciding the place to which a function is added.

That is to say, the function added document data 20i in which a function specified by the user is added to a place on a page to which the function addition marker 62 is added is generated by the adding place setting portion 21b, the function generation portion 21e and the function adding portion 21f.

In this manner, in the document data 20a, the condition of the number of blank lines is used as the condition for deciding a place to which a function is added, therefore, it becomes possible to add a function to a place having a blank line so as to prevent from impairing readability of a document.

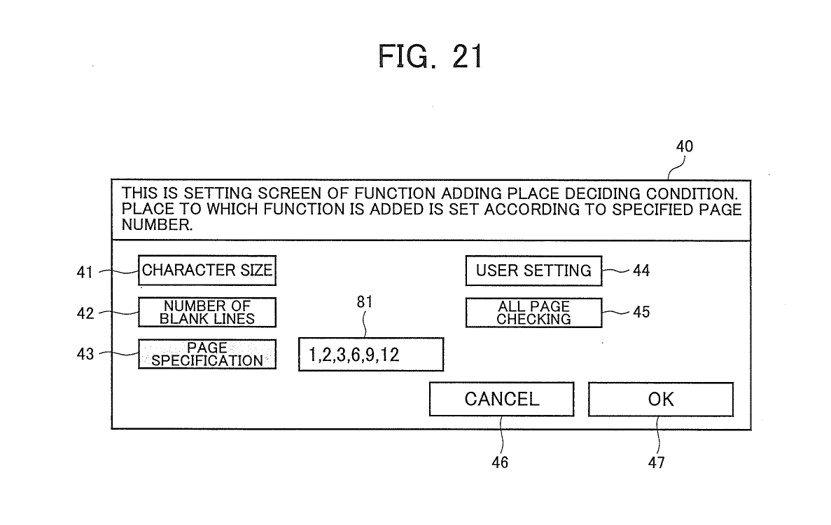

Next, a case will be described where a condition of page specification is specified by a user as the condition for deciding a place to which a function is added. FIG. 21 is a diagram showing an example of a condition setting screen 40 on which a condition of page specification is specified.

On the condition setting screen 40 shown in FIG. 6, when a user touches the page specification button 43, a page input area 81 is displayed as shown in FIG. 21, The page input area 81 is an area in which a page number input by operating the input key portion 11c and the like by the user is displayed. In the example of FIG. 21, respective page numbers of “1, 2, 3, 6, 9 and 12” are displayed in the page input area 81.

On the condition setting screen 40 an example of which is shown in FIG. 21, when the page number is input by a user, the function adding portion 21f controls the display portion 11a to display as a list the function addition page numbers 56 on pages corresponding to the input page numbers.

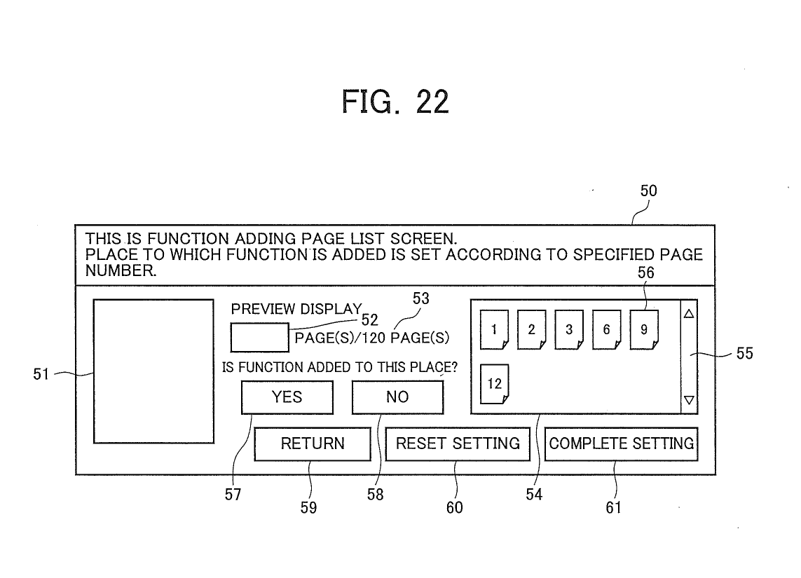

FIG. 22 is a diagram showing an example of the page list display screen 50 for displaying a page searched on a condition of page specification, and the page list display screen 50 shown in FIG. 22 is different from the page list display screen 50 shown in FIG. 11 in that the function addition page number 56 displayed in the page list display area 54 is the function addition page number 56 on the page searched on the condition of the page specification.

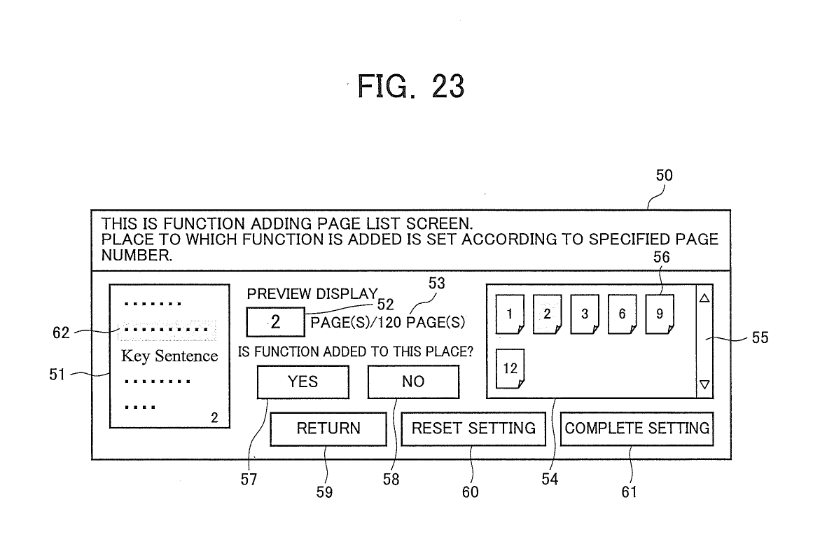

FIG. 23 is a diagram showing an example of the page list display screen 50 in the case where a page is selected, and in the example of FIG. 23, in the page list display area 54, the function addition page number 56 on the 2nd page is selected by the user. In this case, a display color of the function addition page number 56 is changed. Moreover, in the page number display area 52, “2” is displayed. Further, in the preview area 51, an image picture on the 2nd page is displayed.

In the case of using the condition of the page specification as the condition for deciding a place to which a function is added, a place to which the function addition marker 62 is added on each page is assumed to be set in advance by a user. Thereby, in the place to which such setting has been made in the image picture displayed in the preview area 51, the function addition marker 62 indicating to add a function is added. Subsequent processing is the same as in the case where the user specifies the condition of the character size as the condition for deciding the place to which a function is added.

That is to say, the function added document data 20i in which a function specified by a user is added to a place on a page to which the function addition marker 62 is added is generated by the adding place setting portion 21b, the function generation portion 21e and the function adding portion 21f.

In this manner, since the condition of the page specification is used as the condition for deciding a place to which a function is added in the document data 20a, it becomes possible to add a function to a page which is desired by the user so as to be able to reflect a request of the user faithfully.

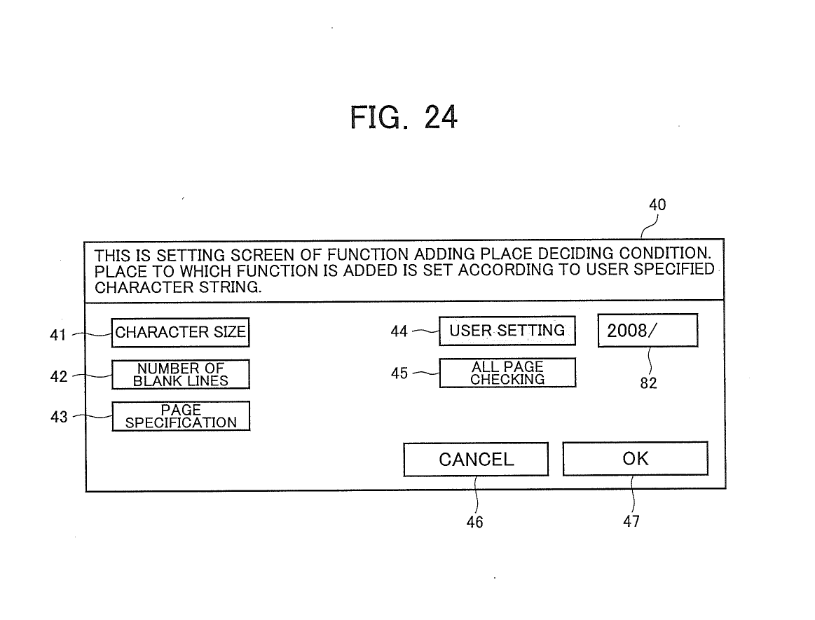

Next, a case will be described where a condition of user setting is specified by a user as the condition for deciding a place to which a function is added. FIG. 24 is a diagram showing an example of the condition setting screen 40 on which a condition of user setting is specified.

On the condition setting screen 40 shown in FIG. 6, when the user setting button 44 is touched by a user, a character string input area 82 is displayed as shown in FIG. 24. The character string input area 82 is an area in which a character string which is input by operating the input key portion 11c and the like by the user is displayed. In the example of FIG. 24, “2008/” is displayed in the character string input area 82.

On the condition setting screen 40 shown in FIG. 24, when the character string is input by the user, the function adding portion 21f controls the display portion a to display pages as a list, each of which includes the input character strings.

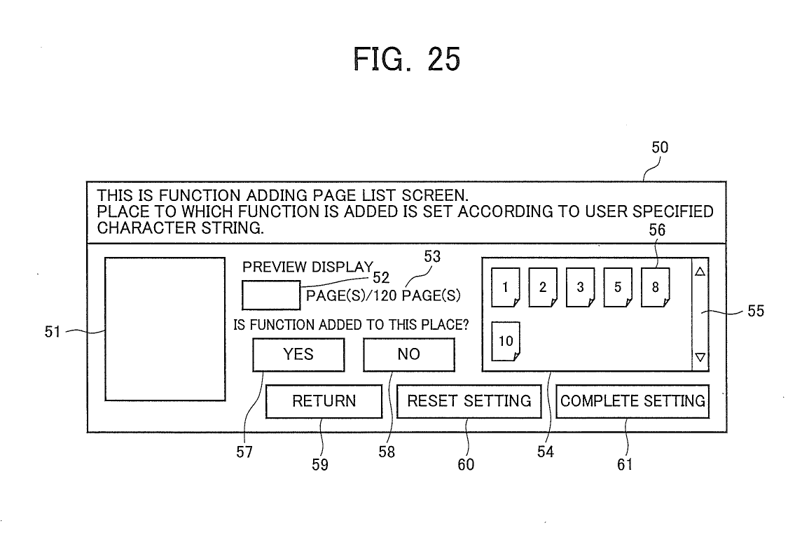

FIG. 25 is a diagram showing an example of a page list display screen 50 displaying a page searched on the condition of user setting, and the page list display screen 50 shown in FIG. 25 is different from the page list display screen 50 shown in FIG. 11 in that the function addition page number 56 displayed in the page list display area 54 is the function addition page number 56 on the page searched on the condition of the user setting.

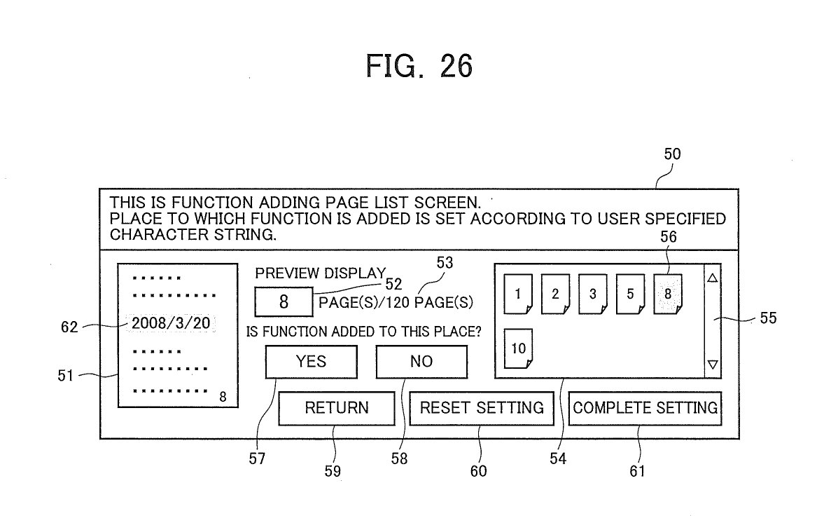

FIG. 26 is a diagram showing an example of a page list display screen 50 in the case where a page is selected, and in the example of FIG. 26, in the page list display area 54, the function addition page number 56 on the 8th page is selected by the user. In this case, a display color of the function addition page number 56 is changed. Moreover, in the page number display area 52, “8” is displayed. In the preview area 51, an image picture on the 8th page is further displayed.

In the image picture displayed in the preview area 51, the function addition marker 62 indicating that a function is added to the place is added to the place including the character string of “2008/”. Subsequent processing is the same as the in case where the user specifies the condition of the character size as the condition for deciding the place to which a function is added.

That is to say, the function added document data 20i in which a function specified by a user is added to a place on a page to which the function addition marker 62 is added is generated by the adding place setting portion 21b, the function generation portion 21e and the function adding portion 21f.

In this manner, since the condition of the user setting is used as the condition for deciding a place to which a function is added in the document data 20a, it becomes possible to add a function to a desired place on a page desired by the user so as to be able to reflect a request of the user faithfully.

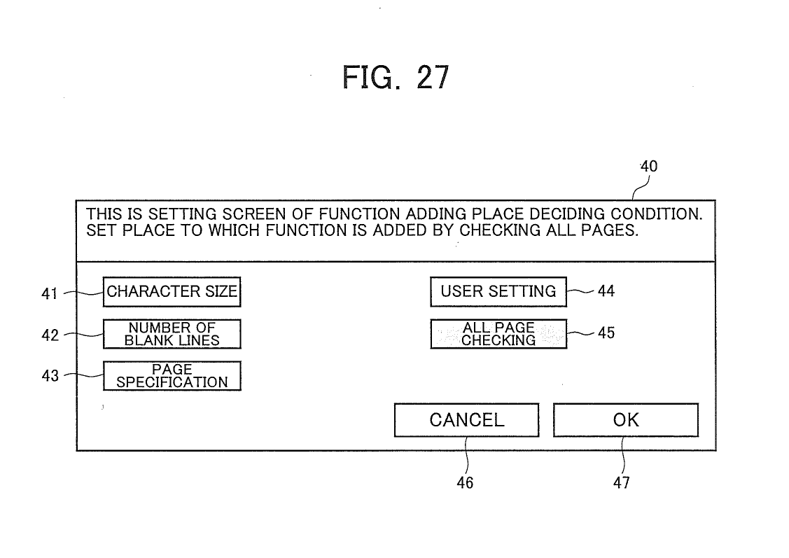

Next, a case will be described where a condition of all page checking is specified by a user as the condition for deciding a place to which a function is added. FIG. 27 is a diagram showing an example of the condition setting screen 40 on which the condition of all page checking is specified.

On the condition setting screen 40 shown in FIG. 27, when the all page checking button 45 is touched by a user, and the OK button 47 is further touched, the page list display screen 50 in which the function addition page number 56 is not displayed is displayed in the page list display area 54.

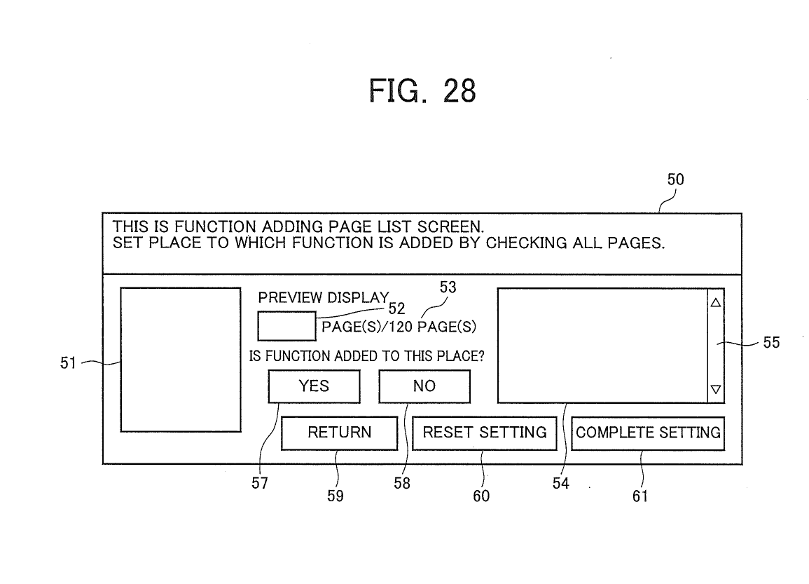

FIG. 28 is a diagram showing an example of a page list display screen 50 displayed when the condition of the all page checking is specified, and the page list display screen 50 displayed in FIG. 28 is different from the page list display screen 50 shown in FIG. 11 in that the function addition page number 56 is not displayed in the page list display area 54.

The user inputs a page number in the page number display area 52 by operating the input key portion 11c and the like, and further specifies a place to which a function is added on a page corresponding to the page number so as to add the function addition marker 62 to the page.

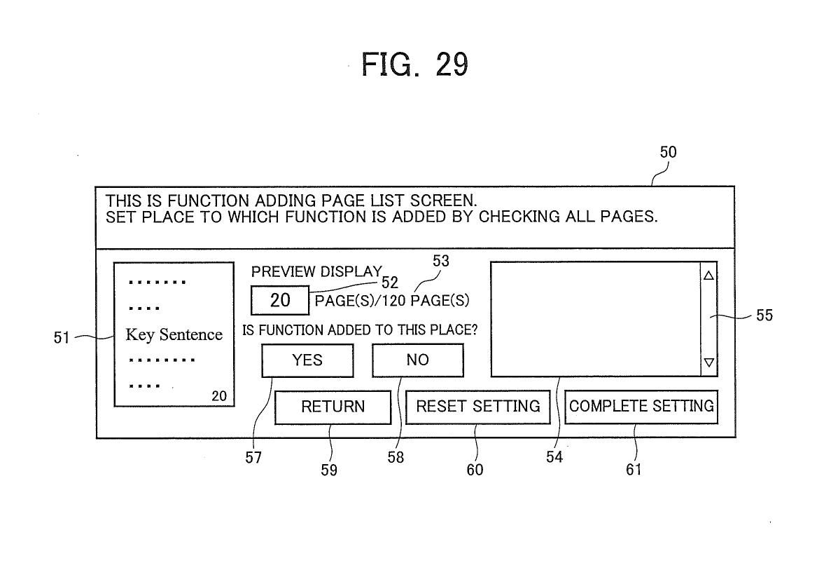

FIG. 29 is a diagram showing an example of a page list display screen 50 in which a page number is input in the page number display area 52, and as shown in FIG. 29, when the user inputs the page number in the page number display area 52, an image picture of the page corresponding to the page number is displayed in the preview area 51. The user then traces the image picture displayed in the preview area 51 with his/her finger to specify a place to which the function addition marker 62 is added.

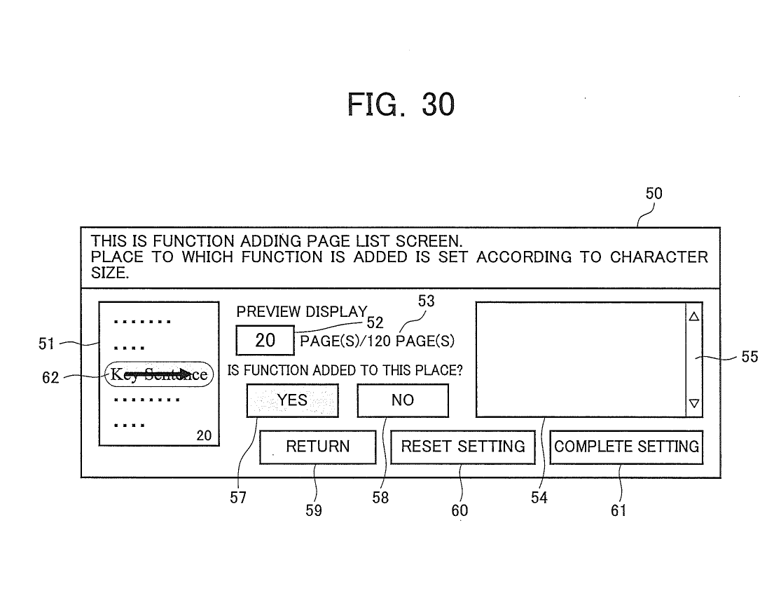

FIG. 30 is a diagram showing an example of the page list display screen 50 in the case where a place to which the function addition marker 62 is added is specified, and in the example of FIG. 30, as the result of input of “20” in the page number display area 52 as the page number by the user, an image picture on the 20th page is displayed in the preview area 51.

Further, as the result of the character string of “Key Sentence” traced by the user with his/her finger, the function addition marker 62 is added to a line including the character string of “Key Sentence”.

Then, when the adding place setting button 57 shown in FIG. 30 is touched by the user, the adding place setting portion 21b sets the place to which the function addition marker 62 is added as a place to which a function is added. The function adding portion 21f then controls the display portion 11a to display in the page list display area 54 the function addition page number 56 on the page set as a place to which a function is added.

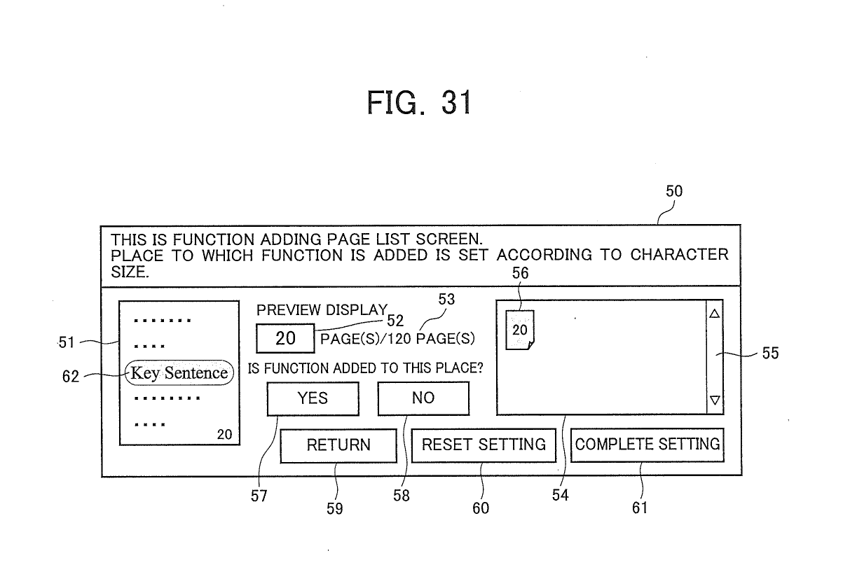

FIG. 31 is a diagram showing an example of the page list display screen 50 displaying a page to which a place to which a function is added is set, and in the page list display area 54 in FIG. 31, the function addition page number 56 on the 20th page which is set as the page to which a function is added is displayed.

In the case of deciding a place to which a function is added on the condition of the all page checking, the user repeats the operation of specifying the page and the operation to decide a place to which a function is added as described above. In the page list display area 54, then, the function addition page number 56 is displayed as many as the number of pages specified by the user as the page to which a function is added.

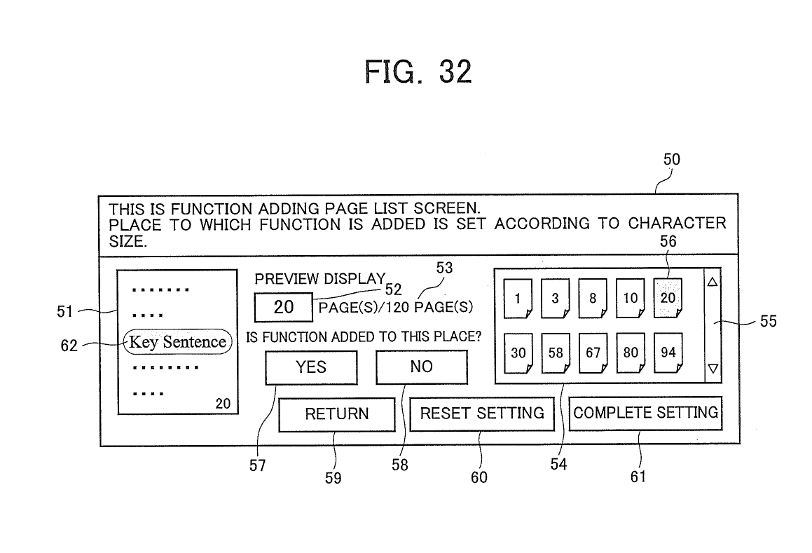

FIG. 32 is a diagram showing an example of a page list display screen 50 in the case where there are a plurality of pages on which places to which functions are added are set, and in the page list display area 54 in FIG. 32, the function addition page numbers 56 on pages 1, 3, 8, 10, 20, 30, 58, 67, 80 and 94 specified by the user as the page to which a function is added are displayed.

Then, any of the plurality of function addition page numbers 56 displayed in the page list display area 54 is touched by the user and an image picture of the page corresponding to the touched function addition page number 56 is displayed in the preview area 51.

Subsequent processing is the same as in the case of the condition of the character size is specified by the user as the condition for deciding the place to which a function is added. That is to say, the function added document data 20i in which a function specified by the user is added to a place on a page to which the function addition marker 62 is added is generated by the adding place setting portion 21b, the function generation portion 21e and the function adding portion 21f.

Note that, in the above embodiments, the case has been described where the user specifies one condition on the condition setting screen 40 shown in FIG. 6, however, the user may select more than one conditions. For example, when a function is added to a place where the number of blank lines is three and the character size in the line following the blank lines is 20 pt or more, the user may touch both the character size button 41 and the number of blank lines button 42 to set the character size and the number of blank lines.

In this case, the character determining portion 21c and the blank line determining portion 21d of the image forming system 10 detect a page having a place where the number of blank lines is three and the character size in the line following the blank lines is 20 pt or more. The function adding portion 21f then controls the display portion 11a to display the function addition page number 56 of the detected page in the page list display area 54 shown in FIG. 11.

The function adding portion 21f thereafter accepts specification of the function addition page number 56 corresponding to the page to which a function is added from among the function addition page numbers 56 displayed in the page list display area 54. The adding place setting portion 21b then adds the function addition marker 62 to the place detected in the specified function addition page number 56.

The function generation portion 21e thereafter generates the function data 20h of the function specified by the user. The function adding portion 21f then executes processing to embed the generated function data 20h in a place of the document data 20a to which the function addition marker 62 is added.

Although the embodiments of the image forming system and the function adding method have been mainly described so far, the present invention is not limited to these embodiments and the present invention may be implemented as a form of a computer program for realizing functions of the image forming system or a form of a computer readable recording medium having the computer program recorded therein.

Here, the recording medium may employ various forms of a disk type (for example, such as a magnetic disk and an optical disk), a card type (for example, such as a memory card and an optical card), a semiconductor memory type (for example, such as a ROM and a non-volatile memory), a tape type (for example, such as a magnetic tape and a cassette tape) and the like.

Such a recording medium having a computer program which realizes the functions of the image forming system in the above embodiments or a computer program which causes a computer to execute the function adding method recorded therein is distributed so as to be able to reduce costs and improve portability or versatility.

The above recording medium is then mounted to a computer, a computer program recorded in the recording medium is read by the computer to be stored in a memory, and the computer program is read from the memory by a processor (CPU: Central Processing Unit, MPU: Micro Processing Unit) provided in the computer for execution, so that it is possible to realize the functions of the image forming system according to these embodiments and execute the function adding method.

Moreover, the present invention is not limited to the above embodiments and may variously be modified and altered within a range without departing from the spirit of the present invention. For example, the instruction or the data required to generate the function added document data 20i may be transferred from an external device.

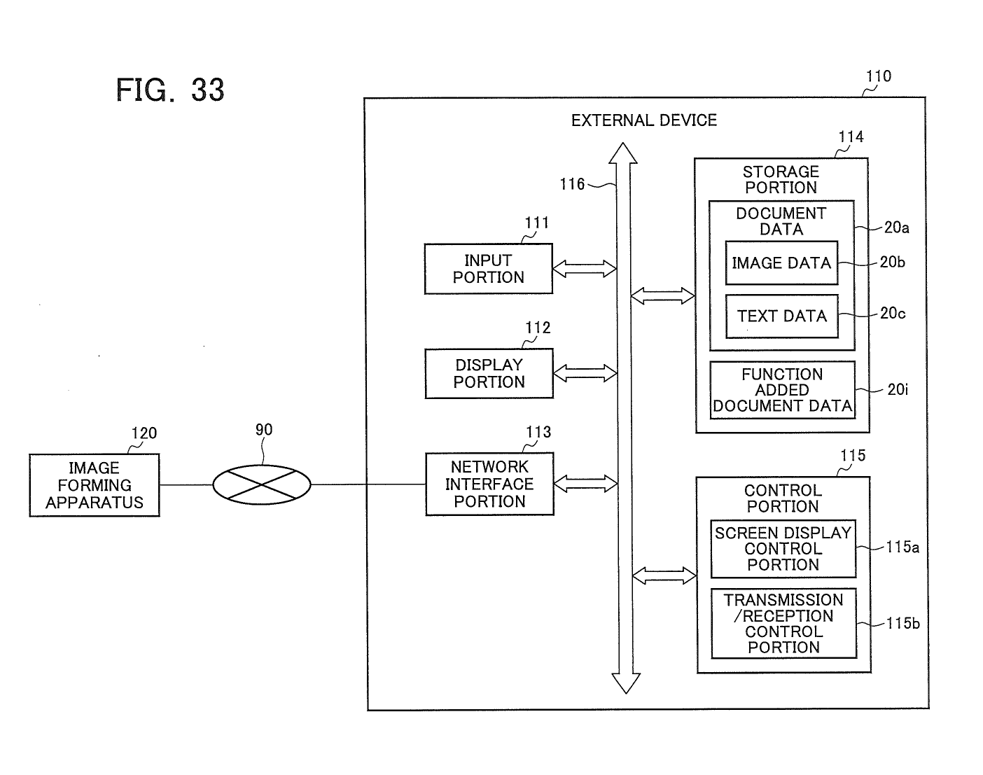

FIG. 33 is a block diagram showing an example of a configuration of the image forming system 100 in which a required instruction or data is transferred from an external device 110, and the image forming system 100 is provided with an image forming apparatus 120 and the external device 110. The image forming apparatus 120 and the external device 110 are then connected to each other via a network 90. The image forming apparatus 120 is an apparatus similar to the image forming system 10 shown in FIG. 2.

The external device 110 is provided with an input portion 111, a display portion 112, a network interface portion 113, a storage portion 114, a control portion 115 and a system bus 116.

The input portion 111 is an input device such as a mouse or a keyboard. The display portion 112 is a display device such as a liquid crystal display. The network interface portion 113 is an interface portion to perform communication with the image forming apparatus 120 via the network 90.

The storage portion 114 is a storage device such as a memory or a hard disk device and the storage portion 114 stores the document data 20a and the function added document data 201. The document data 20a includes the image data 20b and the text data 20c.

The document data 20a, the image data 20b, the text data 20c and the function added document data 20i are similar to the document data 20a, the image data 20b, the text data 20c and the function added document data 20i which has been described in FIG. 2.

The control portion 115 is a control device such as a CPU (Central Processing Unit) which totally controls the external device 110. The control portion 115 is provided with the screen display control portion 115a and a transmission/reception control portion 115b.

The screen display control portion 115a is a processing portion which controls the display portion 112 to display on the display portion 112 the same screen as the screen displayed on the display portion 11a of the image forming apparatus 120. For example, the screen display control portion 115a obtains information of various screens one example of which is shown in FIG. 5, FIG. 6, FIG. 10 to FIG. 13, and FIG. 15 to FIG. 32, and displays the various screens on the display portion 112 using the obtained information.

The transmission/reception control portion 115b performs processing such as transmitting to the image forming apparatus 120 the document data 20a or information input by a user via the input portion 111, or receiving from the image forming apparatus 120 the information of the various screens or the function added document data 201 generated by the image forming apparatus 120.

Specifically, the transmission/reception control portion 115b transmits to the image forming apparatus 120 the information input by operating the input portion 111 by the user on the various screens one example of which are shown in FIG. 5, FIG. 6, FIG. 10 to FIG. 13, and FIG. 15 to FIG. 32.

The image forming apparatus 120 which received the information generates the function added document data 20i to which various functions are added by the above-described function adding processing and transmits the generated function added document data 20i to the external device 110.

The external device 110 which received the function added document data 20i stores the received function added document data 20i in the storage portion 114. The function added document data 20i is transferred to a mobile terminal such as an electronic book terminal according to a request of a user so as to be viewed by the user and the added function is used.

The system bus 116 is a system bus for connecting between respective function portions. The system bus 116 includes a data bus, an address bus, a control signal bus, and the like.

In this manner, even when the instruction or the data required to generate the function added document data 20i is transferred from the external device, it is possible to easily and effectively add information to various places of the document data 20a according to a request from a user of the moment.

Hereinabove, according to the present invention, specification of at least one condition is accepted from among a plurality of conditions for deciding a place to which a predetermined function is added in document data; a list of pages each of which includes a place which is matched with the condition of which specification is accepted is displayed, a page to which the predetermined function is added is selected from among the pages included in the displayed list and the place in the selected page matched with the condition of which specification is accepted is set as a place to which the predetermined function is added, so that it is possible to easily and efficiently add information to various places of the document data according to a request from a user of the moment.

1. An image forming system in which a predetermined function is added to computerized document data, comprising:
a condition specification accepting portion which accepts specification of at least one condition from among a plurality of conditions for deciding a place to which the predetermined function is added in the document data;
a display portion which displays a list of pages each of which includes a place which matches with the condition on which specification is accepted by the condition specification accepting portion; and
an adding place setting portion which selects a page to which the predetermined function is added from among the pages included in the list displayed by the display portion, and in the selected page, sets the place which matches with the condition on which specification is accepted, as the place to which the predetermined function is added.

2. The image forming system as defined in claim 1, wherein
the condition includes a condition of a character size in the place to which the predetermined function is added.

3. The image forming system as defined in claim 1, wherein
the condition includes a condition of the number of blank lines in the place to which the predetermined function is added.

4. The image forming system as defined in claim 1, wherein
the condition includes a condition that the place to which the predetermined function is added is included in a page specified by a user.

5. The image forming system as defined in claim 1, wherein
the condition includes a condition that the place to which the predetermined function is added is a place specified by a user on a page specified by the user.
